(19) United States
(12) Patent Application Publication
(10) Pub. No.: US 2026/0326278 A1
(43) Pub. Date: Oct. 22, 2026

(54) POWER TOOL

(71) Applicant: MAKITA CORPORATION, Anjo-shi (JP)

(72) Inventors: Akira MIZUTANI, Anjo-shi (JP); Takafumi KOTSUJI, Anjo-shi (JP); Yoshihiro OZEKI, Anjo-shi (JP); Masatoshi NAKAHAMA, Anjo-shi (JP)

(73) Assignee: MAKITA CORPORATION, Anjo-shi (JP)

(21) Appl. No.: 19/643,465

(22) Filed: Apr. 9, 2026

(30) Foreign Application Priority Data
Apr. 18, 2025 (JP) 2025-068508
Dec. 5, 2025 (JP) 2025-234696

(51) Int. Cl. B25F 5/02

(52) U.S. Cl. CPC B25F 5/02

(57) ABSTRACT

To provide a mounting mechanism for mounting a tool accessory to a power tool in a simple operation. A power tool includes: an opening/closing mechanism that fixes the tool accessory; a moving part that is connected to the opening/closing mechanism so as to be allowed to displace in a first direction and a second direction, and operates the opening/closing mechanism in a closing direction when moved in the first direction, while operating the opening/closing mechanism in an opening direction when moved in the second direction; and a biasing force control mechanism, including a shaft member that has one end connected to the moving part, a biasing part that generates a biasing force, and a cylindrical member that houses the shaft member, the biasing part and the moving part. The biasing force control mechanism is configured to switch the state of application of the biasing force. When a prescribed external force is applied from the tool accessory, the biasing force control mechanism applies the biasing force to the shaft member in a direction to move the moving part in the second direction by changing a state of the shaft member locked to the cylindrical member.

### TECHNICAL FIELD

The present invention relates to a power tool.

### BACKGROUND ART

A power tool is known that processes a workpiece by driving a spindle with a motor to oscillatingly drive a tool accessory mounted to the spindle.

Generally, in such a power tool, the spindle is provided with a tool accessory mounting mechanism configured such that various types of tool accessories can be replaceably mounted to the spindle according to the operation. In the technical field of power tools, various configurations of the mounting mechanism have been proposed to facilitate the mounting of the tool accessory.

For example, Patent Document 1 (Japanese Patent No. 7330914) discloses a configuration in which, when a cylindrical locking member is pushed up by a tool accessory during mounting of the tool accessory, two claws that have been locked in a closed state within a cylinder of the locking member come out of the cylinder and open to fix the tool accessory.

### SUMMARY OF THE INVENTION

### Problem to be Solved by the Invention

In power tools, as in the configuration disclosed in Patent Document 1, it is preferable that the tool accessory can be mounted by a simple one-touch operation. In the configuration of Patent Document 1, however, in the state before the tool accessory is mounted, the two claws are locked in abutment with the locking member within the cylinder of the locking member. Therefore, due to friction between the locking member and the claws, or sticking between the locking member and the claws, the locking member may not be easily pushed up and the claws may not be easily opened.

As described above, in the power tool, there is still room for improvement in the mounting mechanism that enables the tool accessory to be mounted to the power tool by a simple one-touch operation.

### Means for Solving the Problem

According to one aspect of the present disclosure, a power tool is provided which is configured to perform an operation on a workpiece by oscillating a tool accessory. The power tool according to this aspect includes:
an opening/closing mechanism configured to open and close so as to allow attachment and detachment of the tool accessory when in an open state, while fixing the tool accessory when in a closed state;
a moving part connected to the opening/closing mechanism so as to be movable in a first direction and a second direction opposite to the first direction, the moving part being configured to operate the opening/closing mechanism in a closing direction when moved in the first direction, and to operate the opening/closing mechanism in an opening direction when moved in the second direction; and
a biasing force control mechanism including a shaft member having one end connected to the moving part to move together with the moving part, a biasing part that generates a biasing force, and a cylindrical member that surrounds an outer periphery of the shaft member and houses the biasing part, the biasing force control mechanism being configured to switch a state of application of the biasing force, wherein:
(a) in the closed state of the opening/closing mechanism, the biasing force control mechanism applies the biasing force to hold the opening/closing mechanism in the closed state; and
(b) when a prescribed external force is applied from the tool accessory against the biasing force in said closed state, the biasing force control mechanism changes a state in which the shaft member is locked to the cylindrical member, to apply the biasing force to the shaft member in a direction to move the moving part in the second direction.

According to the power tool of this configuration, the closed state of the opening/closing mechanism can be maintained by the biasing force applied by the biasing force control mechanism. Further, when the prescribed external force is applied from the tool accessory in the closed state of the opening/closing mechanism, the biasing force control mechanism changes the state in which the shaft member is locked to the cylindrical member, thereby applying the biasing force to the shaft member in the second direction. By this, the moving part can be moved in the second direction to open the opening/closing mechanism, enabling the tool accessory to be fixed. With this configuration, the tool accessory can be mounted to the power tool by a simple one-touch operation of merely applying the prescribed external force from the tool accessory.

### BRIEF DESCRIPTION OF THE DRAWINGS

FIG. 1 is a schematic cross-sectional view of a power tool.

FIG. 2 is a schematic perspective view showing a mounting mechanism of a first embodiment.

FIG. 3 is a schematic exploded perspective view of the mounting mechanism of the first embodiment.

FIG. 4 is a schematic sectional view showing the mounting mechanism of the first embodiment.

FIG. 5 is an explanatory view showing an operation of an opening/closing mechanism.

FIG. 6 is an explanatory view showing an operation of a biasing force control mechanism of the first embodiment.

FIG. 7 is a schematic cross-sectional view showing a state in which a tool accessory is fixed to a tool mounting part.

FIG. 8 is an explanatory view showing an operation of a tool detaching mechanism.

FIG. 9 is a schematic perspective view showing an appearance of a mounting mechanism of a second embodiment.

FIG. 10 is a schematic exploded perspective view of the mounting mechanism of the second embodiment.

FIG. 11 is a schematic cross-sectional view showing the mounting mechanism of the second embodiment.

FIG. 12 is a schematic cross-sectional view showing a groove of an inner wall surface of a cylindrical member of the second embodiment.

FIG. 13 is an explanatory view showing an operation of a biasing force control mechanism of the second embodiment.

FIG. 14 is a schematic perspective view showing an appearance of a mounting mechanism of a third embodiment.

FIG. 15 is a schematic exploded perspective view of the mounting mechanism of the third embodiment.

FIG. 16 is a schematic cross-sectional view showing the mounting mechanism of the third embodiment.

FIG. 17 is a schematic perspective view showing a biasing part of the third embodiment.

FIG. 18 is a schematic perspective view showing fixation of the biasing part to a shaft member in the third embodiment.

FIG. 19 is an explanatory view showing an operation of a biasing force control mechanism of the third embodiment.

FIG. 20 is a schematic cross-sectional view showing a front part of the power tool of a fourth embodiment.

FIG. 21 is a schematic cross-sectional view showing a mounting mechanism of the fourth embodiment.

FIG. 22 is a schematic exploded perspective view showing the mounting mechanism of the fourth embodiment.

FIG. 23 is a schematic perspective view showing an operation of a detaching operation part of the fourth embodiment.

### DETAILED DESCRIPTION OF THE EMBODIMENTS

In another aspect of the present disclosure, the biasing part may be configured to generate, as the biasing force, a biasing force for biasing the moving part in the first direction and a biasing force for biasing the shaft member in a rotating direction around a center axis. The biasing force control mechanism may be configured such that: (a) the shaft member moves in the second direction together with the moving part as the shaft member rotates in the rotating direction relative to the cylindrical member; (b) in the closed state of the opening/closing mechanism, the biasing force control mechanism applies the biasing force to the moving part to hold the closed state by restricting movement of the moving part in the second direction, while restricting the shaft member from rotating by the biasing force in the rotating direction by locking the shaft member to the cylindrical member; and (c) when the prescribed external force is applied in the closed state, the biasing force control mechanism releases the shaft member from being locked in the rotating direction so as to rotate the shaft member in the rotating direction relative to the cylindrical member by the biasing force applied in the rotating direction, thereby moving the shaft member in the second direction.

According to the power tool of this configuration, when the shaft member is restricted from rotating by being locked to the cylindrical member, the moving part is biased in the first direction, and the opening/closing mechanism is held in the closed state. When the external force is applied from the tool accessory in the closed state of the opening/closing mechanism, the shaft member is released from being locked to the cylindrical member in the rotating direction, and the shaft member rotates by the action of the biasing force and moves in the second direction. Accordingly, the moving part moves in the second direction to open the opening/closing mechanism. In the power tool of this configuration, by changing the state in which the shaft member is locked to the cylindrical member, it is possible to switch the state of application of the biasing force to the shaft member between a state in which the biasing force in the first direction is applied and a state in which the biasing force in the rotating direction is applied. Therefore, movement of the moving part connected to the shaft member in the second direction can be controlled, and the opening/closing operation of the opening/closing mechanism can be easily controlled. With this configuration, the tool accessory can be mounted to the power tool by a simple one-touch operation.

In one or more embodiments of the present disclosure, the biasing part may be configured by a torsion spring that is disposed around an outer periphery of the shaft member and configured to generate the biasing force in the rotating direction by torsional deformation in a winding direction, and to generate the biasing force in the first direction by contracting/extending deformation.

In the power tool of this configuration, the biasing force in the first direction and the biasing force in the rotating direction are generated by the torsion spring that is arranged around the shaft member to control opening and closing of the opening/closing mechanism. Thus, the number of components of the biasing force control mechanism can be reduced, and the biasing force control mechanism can be reduced in size.

In one or more embodiments of the present disclosure, the shaft member may include a protruding part that is formed on an outer peripheral surface thereof and protrudes toward the cylindrical member. The cylindrical member may include a groove into which the protruding part is inserted and that defines a path along which the protruding part moves. The groove may include: a restricted region that extends in a direction along a center axis of the shaft member and restricts the protruding part from moving in the rotating direction by locking the protruding part in the rotating direction; and an allowed region that bends and extends from the restricted region in an oblique direction between the rotating direction and the second direction and allows the protruding part to move in the rotating direction. The biasing force control mechanism may be configured to position the protruding part in the restricted region in the closed state of the opening/closing mechanism, and to move the shaft member in the second direction, thereby moving the protruding part to the allowed region when the prescribed external force is applied in the closed state of the opening/closing mechanism.

In the power tool of this configuration, the state of the shaft member is switched between a state in which the shaft member is locked to the cylindrical member in the second direction and a state in which such locking is released, according to the position of the protruding part of the shaft member within the groove of the cylindrical member. In the power tool of this configuration, the switching of the state of application of the biasing force for opening and closing the opening/closing mechanism is easily realized with a simple configuration of cooperating the protruding part of the shaft member and the groove of the cylindrical member.

In one or more embodiments of the present disclosure, the power tool may further include a shaft support part that is provided within the cylindrical member and includes a plurality of rolling bodies arranged around an outer periphery of the shaft member, wherein the shaft support part may be configured to guide rotation of the shaft member in the rotating direction and movement of the shaft member in the first and second directions by rolling of the rolling bodies.

In the power tool of this configuration, the shaft member is supported to rotate and move in an appropriate orientation within the cylindrical member, while avoiding or reducing friction by the provision of the rolling bodies. Thus, the shaft member is smoothly moved in an appropriate orientation within the cylindrical member, so that the tool accessory is more smoothly attached to and detached from the opening/closing mechanism.

In one or more embodiments of the present disclosure, the groove may be formed so as to pass through a wall of the cylindrical member, and a rotation support part may be provided around an outer periphery of the cylindrical member at a position facing the groove. The rotation support part may be configured to support the cylindrical member in a state of allowing the cylindrical member to rotate around the center axis together with the tool accessory when the tool accessory oscillates.

In the power tool of this configuration, by the provision of the groove formed through the wall of the cylindrical member, the protruding part can be deeply inserted into the groove so as to be prevented or restrained from coming off from the groove. Further, by the provision of the rotation support part, the cylindrical member is more smoothly rotated, and the protruding part is prevented or restrained from protruding to the outside of the cylindrical member through the groove. Furthermore, entry of fine foreign matters such as dust into the cylindrical member through the groove is prevented or reduced.

In one or more embodiments of the present disclosure, the power tool may further include: a lever operation part that is arranged above the cylindrical member and is configured to be turned by a user in a direction around the center axis of the shaft member; a lever connection part that is arranged below the lever operation part and is connected to an upper end part of the shaft member so as to rotate in the rotating direction around the center axis together with the shaft member; and an intervening member that is provided between the lever operation part and the lever connection part. The intervening member may be configured to generate a force for rotating the shaft member in the direction around the center axis and a force for moving the shaft member in the first direction when the lever operation part is turned around the center axis.

In the power tool of this configuration, when a user turns the lever operation part with the tool accessory fixed to the opening/closing mechanism, the shaft member is rotated in the direction around the center axis against the biasing force of the biasing part. Accordingly, the moving part is moved in the first direction to return the opening/closing mechanism to the closed state, so that the tool accessory can be detached from the opening/closing mechanism. In this detaching operation of the tool accessory, since the intervening member applies an external force to the shaft member through the lever connection part to move the shaft member in the first direction, the moving part moves more smoothly in the first direction by the turning of the lever operation part. Thus, the opening/closing mechanism is more smoothly returned to the closed state, and the tool accessory is more smoothly detached from the opening/closing mechanism.

In one or more embodiments of the present disclosure, the shaft member may be arranged so as to be rotatable in a rotating direction around a center axis relative to the cylindrical member. The biasing part may include a biasing member that biases the shaft member in the second direction. The biasing force control mechanism may be configured to, when the shaft member rotates in the rotating direction, switch between: a state in which the shaft member is locked to the cylindrical member to restrict the shaft member from moving in the second direction; and a state in which the shaft member is released from being locked to the cylindrical member to allow the shaft member to move in the second direction. The biasing force control mechanism may be configured to: restrict the shaft member from moving in the second direction in the closed state of the opening/closing mechanism; and rotate the shaft member to release the restriction of movement of the shaft member and move the shaft member in the second direction when a prescribed external force is applied in the closed state of the opening/closing mechanism.

In the power tool of this configuration, the restriction of movement of the shaft member in the second direction is released when the shaft member is rotated, and the biasing force for moving the shaft member in the second direction is applied. Thus, the moving part is moved in the second direction together with the shaft member by the biasing force of the biasing part, so that the opening/closing mechanism is opened. In the power tool of this configuration, the biasing force control mechanism that controls switching of the state of application of the biasing force for opening and closing the opening/closing mechanism is easily realized with a simple configuration of switching the locked state of the shaft member relative to the cylindrical member.

In one or more embodiments of the present disclosure, the shaft member may have a protruding part that is formed on an outer peripheral surface thereof and protrudes toward the cylindrical member. The cylindrical member may have a groove into which the protruding part is inserted and that defines a path along which the protruding part moves. The groove may include: a restricted region that extends in the rotating direction and restricts the protruding part from moving in the second direction; and an allowed region that is bent from the restricted region and extends in the second direction to allow the protruding part to move in the second direction. The biasing force control mechanism may be configured to position the protruding part in the restricted region in the closed state of the opening/closing mechanism, and to rotate the shaft member to move the protruding part to the allowed region when the prescribed external force is applied in the closed state of the opening/closing mechanism.

In the power tool of this configuration, the state of the shaft member is switched between a state in which the shaft member is restricted from moving in the second direction and a state in which such restriction is released, according to the position of the protruding part of the shaft member within the groove of the cylindrical member. In the power tool of this configuration, the switching of the state of application of the biasing force for opening and closing the opening/closing mechanism is realized with a simple configuration of cooperating the protruding part of the shaft member and the groove of the cylindrical member to change the locked state of the shaft member relative to the cylindrical member.

In one or more embodiments of the present disclosure, the biasing force control mechanism may further include a cylindrical moving body that is arranged to surround the outer periphery of the shaft member within the cylindrical member so as to be movable in the first and second directions relative to the opening/closing mechanism, and the cylindrical moving body may have a through hole into which the protruding part is inserted. The through hole may have an inclined wall surface that is inclined obliquely relative to the rotating direction and guides the protruding part in contact therewith. The biasing part may include: a first biasing member that biases the cylindrical moving body in the first direction; and a second biasing member that biases the moving part in the second direction. The biasing force control mechanism may be configured to: position the protruding part at an end part of the inclined wall surface on a side of the second direction by a biasing force of the first biasing member in the closed state of the opening/closing mechanism; and move the cylindrical moving body in the second direction and move the protruding part in the rotating direction along the inclined wall surface to rotate the shaft member and move the shaft member in the second direction by a biasing force of the second biasing member when the prescribed external force is applied in the closed state of the opening/closing mechanism.

In the power tool of this configuration, the configuration of rotating the shaft member when the prescribed external force is applied from the tool accessory in the closed state of the opening/closing mechanism is realized with a simple configuration of cooperating the protruding part of the shaft member and the through hole of the cylindrical moving body. Thus, the biasing force control mechanism that switches the locked state of the shaft member relative to the cylindrical member by the rotation of the shaft member is realized with a simpler configuration.

In one or more embodiments of the present disclosure, the biasing force control mechanism may include a rotating member that is provided around an outer periphery of the shaft member and is connected to the shaft member so as to be rotatable around a center axis of the shaft member relative to the shaft member and the cylindrical member. The rotating member may have a convex part that is formed on an outer peripheral surface thereof facing an inner wall surface of the cylindrical member and protrudes toward the cylindrical member. The cylindrical member may have a groove in which the convex part is housed and that defines a path along which the convex part moves. The groove may include: a restricted region that has a locking inner wall surface for locking the convex part in the second direction and restricts the convex part from moving in the second direction; and an allowed region that extends from the restricted region in an oblique direction between the rotating direction and the second direction and allows the convex part to move in the oblique direction. The biasing force control mechanism may be configured to: position the convex part in the restricted region in the closed state of the opening/closing mechanism, thereby restricting the shaft member from moving in the second direction; and rotate the rotating member to move the convex part to the allowed region, thereby releasing the restriction of movement of the shaft member and moving the shaft member in the second direction by action of the biasing force when the prescribed external force is applied in the closed state of the opening/closing mechanism.

In the power tool of this configuration, the state of the shaft member is switched between a state in which the shaft member is restricted from moving in the second direction and a state in which such restriction is released, according to the position of the convex part of the rotating member within the groove of the cylindrical member. In the power tool of this configuration, the biasing force control mechanism that controls switching of the state of application of the biasing force for opening and closing the opening/closing mechanism is realized with a simple configuration of cooperating the convex part of the rotating member and the groove of the cylindrical member.

In one or more embodiments of the present disclosure, the convex part may be constituted by a rolling member that is configured to roll at a fixed position, and the groove may have a bottom on which the rolling member rolls.

In the power tool of this configuration, by the provision of the convex part formed by a rolling member, the convex part smoothly moves within the groove. Thus, the rotating member smoothly rotates, and the opening/closing mechanism smoothly opens and closes. Further, in the power tool of this configuration, the groove is closed by the bottom, so that entry of foreign matter into the cylindrical member through the groove is prevented or reduced.

In one or more embodiments of the present disclosure, the biasing force control mechanism may further include a side moving body that is arranged at a side of the opening/closing mechanism so as to be movable in the first and second directions relative to the opening/closing mechanism. The biasing part may include a biasing member that biases the side moving body in the first direction. The side moving body may be arranged at a position where the tool accessory to be mounted to the opening/closing mechanism in the closed state abuts on the side moving body, and the side moving body may be configured to: move in the second direction to abut on the rotating member and rotate the rotating member in the rotating direction when the side moving body abuts on the tool accessory and receives the prescribed external force exceeding the biasing force in the first direction.

In the power tool of this configuration, the configuration of rotating the rotating member when the prescribed external force is applied from the tool accessory is realized with a simple configuration using the side moving body.

Representative and non-limiting embodiments of the present invention are now specifically described with reference to the drawings.

### 1. First Embodiment

### 1-1. Schematic Configuration of the Power Tool

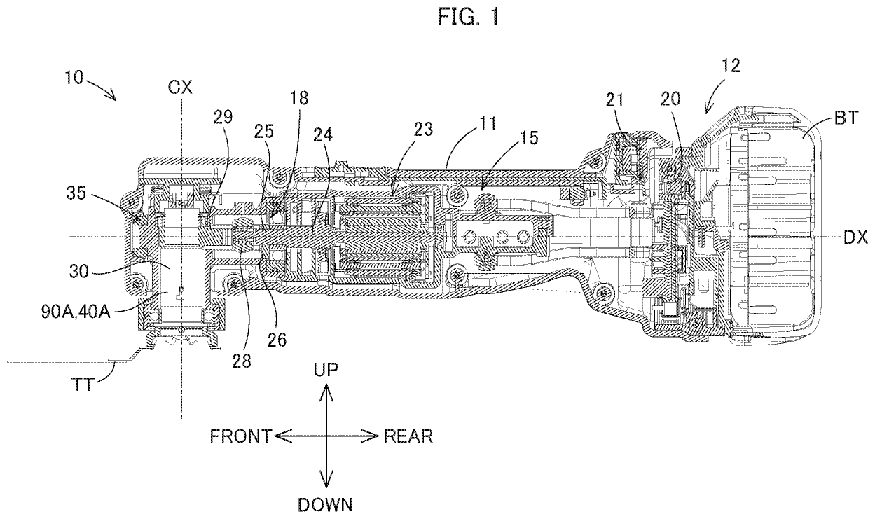

A schematic configuration of a power tool 10 of a first embodiment is described with reference to FIG. 1. FIG. 1 shows a cross-section that passes through a center axis CX and a driving axis DX. In other drawings showing a cross-section, the cross-section is basically taken in the same manner as that of FIG. 1.

For convenience of explanation, as for the directions of the power tool 10, three directions orthogonal to each other, a “front-rear direction,” an “up-down direction,” and a “left-right direction,” are defined as follows.

The power tool 10 has an elongate shape. In the following description, a direction along a longitudinal direction of the power tool 10 is defined as the front-rear direction. In the front-rear direction, one end side to which a tool accessory TT is mounted is defined as a front side or a front end side, and the other end side is defined as a rear side or a rear end side. Further, a direction along the center axis CX of a spindle 30 to which the tool accessory TT is mounted is defined as the up-down direction. In the up-down direction, one end side to which the tool accessory TT is mounted is defined as a lower side, and the opposite side is defined as an upper side. A direction orthogonal to the front-rear direction and the up-down direction is defined as the left-right direction.

In FIG. 1, arrows showing the up-down direction and the front-rear direction are illustrated. The left-right direction is a direction orthogonal to the paper surface in FIG. 1. Arrows showing the front-rear direction, the up-down direction, and the left-right direction are also appropriately shown in the other drawings to correspond to the above-described definitions.

The power tool 10 is an example of an electric work tool that processes a workpiece (not shown) by oscillatingly driving the tool accessory TT. The tool accessory TT is mounted to a front end part of the power tool 10. The tool accessory TT is mounted to a lower end part of the spindle 30 (described below). The power tool 10 oscillates the tool accessory TT in the left-right direction around the spindle 30.

The power tool 10 is also referred to as a multi-tool, and a plurality of types of tool accessories TT can be replaceably mounted to the power tool 10. A plurality of types of tool accessories TT are provided, and a user can select and mount an arbitrary tool accessory TT to the power tool 10 according to the operation to be performed on the workpiece.

FIG. 1 illustrates a state in which, as an example of a tool accessory TT, an elongate blade used mainly for cutting and having cutting teeth at a front end part is mounted to the power tool 10. The tool accessory TT is not limited to a blade; for example, a scraper, a grinding pad, a polishing pad, or other tool accessories that process a workpiece by bringing a front end part, an outer peripheral edge part, or a lower surface into contact with the workpiece may be employed. Operations performed on a workpiece using the tool accessory TT include, for example, cutting, peeling, grinding, and polishing.

The power tool 10 includes a body housing 11, a power supply part 12, a rotation driving mechanism 15, and a motion converting mechanism 18. The body housing 11 constitutes an outer shell of the power tool 10. The body housing 11 is configured by an elongate hollow member and houses components such as the power supply part 12, the rotation driving mechanism 15, and the motion converting mechanism 18.

The power supply part 12 is provided in a rear end part of the body housing 11. The power supply part 12 has, at a rear end of the body housing 11, a battery mounting part 20 to which a battery BT is replaceably mounted. The power supply part 12 supplies power from the battery BT to the rotation driving mechanism 15. In other embodiments, the power supply part 12 may be configured to supply power received from an external power source through a power cord to the rotation driving mechanism 15.

The power supply part 12 includes a control circuit 21 that controls power to be supplied to the rotation driving mechanism 15. The control circuit 21 functions as a control part (controller) that controls driving of the power tool 10. The control circuit 21 controls start and stop of power supply to the rotation driving mechanism 15 in accordance with an ON/OFF operation of an operation part provided on the body housing 11.

The control circuit 21 controls the rotation speed of a motor 23 by controlling power to be supplied to the motor 23 of the rotation driving mechanism 15. The power tool 10 has a dial-type speed change operation part (not shown). The control circuit 21 changes power to be supplied to the motor 23 according to a rotation angle of the speed change operation part to control the rotation speed of the motor 23. In the power tool 10, an oscillation speed of the tool accessory TT changes according to the rotation speed of the motor 23.

The rotation driving mechanism 15 has the motor 23, a rotary shaft 24, an eccentric shaft 25 and a balancer 26. The motor 23 is a source of driving power of the power tool 10, and is driven by power supply from the power supply part 12. In this embodiment, a commutator motor is used as the motor 23. In other embodiments, a brushless DC motor may be used as the motor 23.

A rotary shaft of the motor 23 is connected to the rotary shaft 24. A center axis of the rotary shaft 24 is shown by a two-dot chain line in FIG. 1, and is also referred to as a “driving axis DX”. The rotary shaft 24 is rotatably supported around the center axis by a ball bearing that is fixed at a prescribed position in the body housing 11, and transmits the rotational driving force of the motor 23 to the eccentric shaft 25. A fan is provided on a front stage of the motor 23 and rotates together with the rotary shaft 24 and generates an air flow for heat dissipation.

The eccentric shaft 25 is configured by a substantially cylindrical metallic member having a smaller diameter than the rotation shaft 24. The eccentric shaft 25 is integrally connected to the rotation shaft 24 and extends forward from a front end of the rotation shaft 24 at a position radially offset from the driving axis DX. The eccentric shaft 25 performs an orbital motion around the driving axis DX at the position radially offset from the driving axis DX by rotation of the rotation shaft 24 when the motor 23 is driven. In the power tool 10, the tool accessory TT is oscillated by this eccentric orbital motion of the eccentric shaft 25.

The balancer 26 is a weight provided on an outer periphery of the rotation shaft 24 and rotates together with the rotation shaft 24. The balancer 26 is fixed to the rotation shaft 24 at a position further toward the front end side than the eccentric shaft 25. The center of gravity of the balancer 26 is set at a position radially offset from the driving axis DX. The center of gravity of the balancer 26 is adjusted such that, by rotation of the balancer 26 when the motor 23 is driven, a centrifugal force is generated in a direction that cancels out a centrifugal force generated by the eccentric orbital motion of the eccentric shaft 25.

The motion converting mechanism 18 connects the tool accessory TT and the eccentric shaft 25 and is configured to convert one cycle of rotational motion of the eccentric shaft 25 into one reciprocating cycle of oscillating motion of the tool accessory TT. The motion converting mechanism 18 includes a bearing 28, a connecting arm 29, the spindle 30 described above that holds the tool accessory TT, and a spindle holding mechanism 35.

The bearing 28 is mounted so as to surround an outer periphery of the eccentric shaft 25 and mediates the connection between the eccentric shaft 25 and the connecting arm 29. The bearing 28 is configured by, for example, a ball bearing.

In this embodiment, an outer peripheral surface of the bearing 28 is spherically curved such that a central portion in a direction along a center axis of the bearing 28 bulges outward in a radial direction orthogonal to the center axis. A bearing having such a curved outer peripheral surface is also referred to as a sphere bearing.

The connecting arm 29 is connected to the eccentric shaft 25 and the spindle 30 and is configured to reciprocatingly pivot in the left-right direction about the spindle 30 by the rotational motion of the eccentric shaft 25. A lower end part of the spindle 30 extends from the body housing 11, and the tool accessory TT is mounted to the lower end part as described above, such that the spindle 30 functions as a pivot for the oscillating motion of the tool accessory TT.

The spindle 30 is held by the spindle holding mechanism 35 at a front end part of the power tool 10 in an orientation in which its center axis CX intersects the driving axis DX. In this embodiment, the center axis CX of the spindle 30 is substantially orthogonal to the driving axis DX. The spindle holding mechanism 35 holds the spindle 30 so as to be rotatable about the center axis CX. The tool accessory TT, which is mounted to a tool mounting part 43 (described below) provided at the lower end of the spindle 30, oscillates as the spindle 30 reciprocatingly rotates about the center axis CX.

The spindle 30 includes a mounting mechanism 40A for attaching and detaching the tool accessory TT. The mounting mechanism 40A includes a biasing force control mechanism 90A that controls a biasing force utilized for mounting the tool accessory TT, and realizes easy mounting of the tool accessory TT by a so-called one-touch operation through control of the biasing force by the biasing force control mechanism 90A. A detailed configuration of the mounting mechanism 40A including the biasing force control mechanism 90A is described below.

### 1-2. Components of the Mounting Mechanism

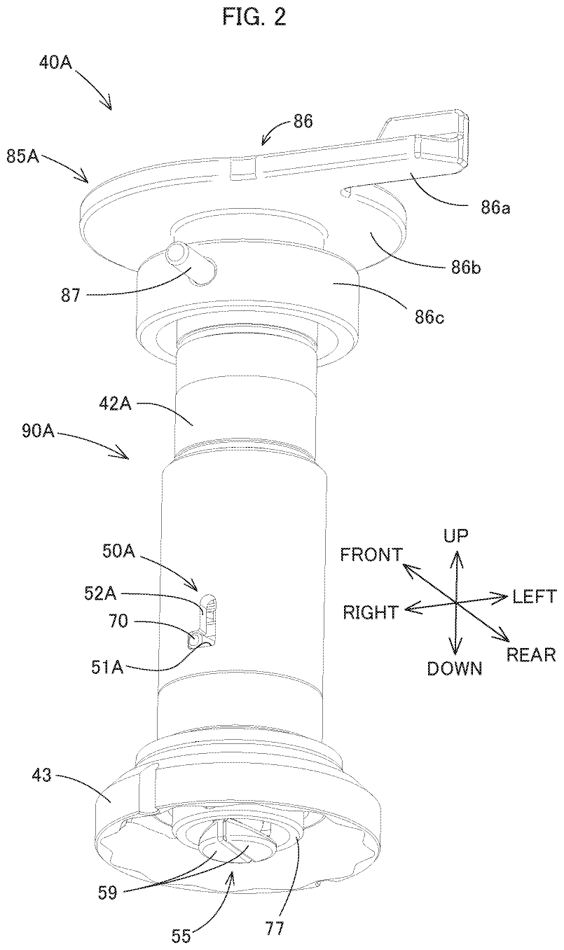

First, components of a mounting mechanism 40A of a first embodiment are described with reference to FIGS. 2, 3, and 4. The mounting mechanism 40A includes a cylindrical member 42A, an opening/closing mechanism 55, a moving part 62A, a shaft member 68A, a biasing part 75A, a cylindrical moving body 77, and a tool detaching mechanism 85A. Each component of the mounting mechanism 40A is described below in order, followed by a description of a biasing force control mechanism 90A that is configured by some of these components.

### Cylindrical Member

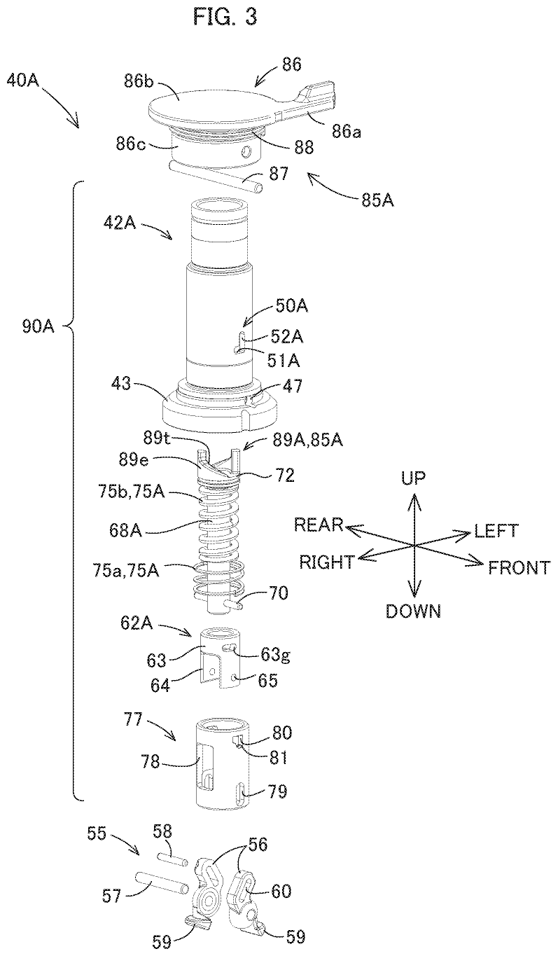

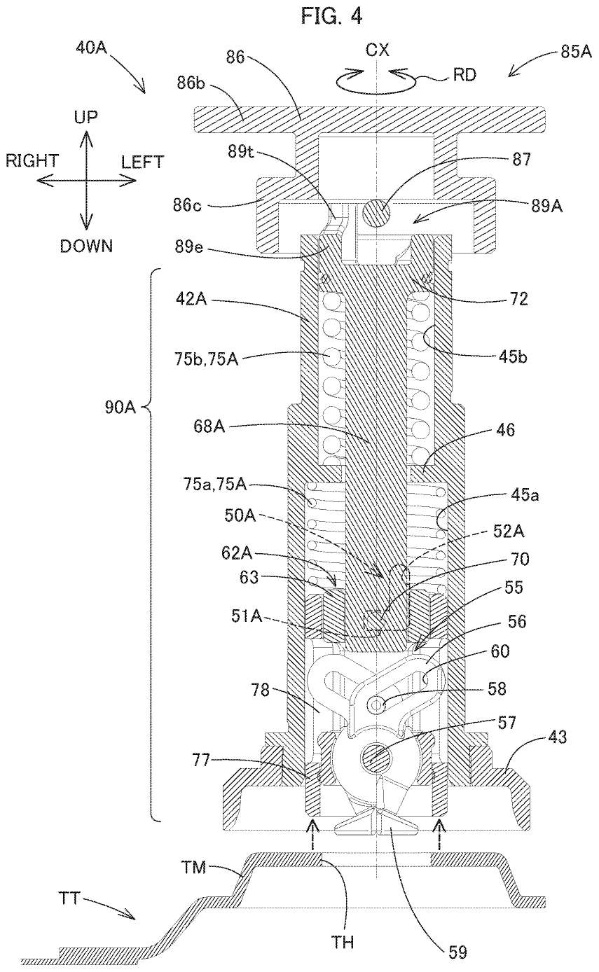

As shown in FIGS. 3 and 4, the cylindrical member 42A is a metallic cylindrical member and constitutes a housing of the mounting mechanism 40A. The cylindrical member 42A also constitutes a body part of the spindle 30. A center axis of the cylindrical member 42A coincides with the center axis CX of the spindle 30. The cylindrical member 42A surrounds an outer periphery of the shaft member 68A and houses the biasing part 75A and the cylindrical moving body 77.

As shown in FIGS. 2 and 4, a tool mounting part 43 that covers a connection part of a tool accessory TT is provided at a lower end of the cylindrical member 42A. The tool mounting part 43 is configured by an annular wall part that surrounds an outer periphery of an opening at the lower end of the cylindrical member 42A. The tool mounting part 43 has a larger diameter than a maximum diameter portion of the cylindrical member 42A. The tool mounting part 43 is configured such that an opening area thereof increases toward the lower end.

At a central portion within the tool mounting part 43, claws 59 at a lower end part of the opening/closing mechanism 55 protrude from the opening at the lower end of the cylindrical member 42A. As described below, the tool accessory TT is fixed to the tool mounting part 43 by being locked with the claws 59 of the opening/closing mechanism 55. An inner wall surface of the tool mounting part 43 is configured to be fitted with a mounting part TM of the tool accessory TT so as to facilitate positioning of the tool accessory TT with respect to the opening/closing mechanism 55.

As shown in FIG. 4, an internal space of the cylindrical member 42A is partitioned into a lower first housing chamber 45a and an upper second housing chamber 45b by a partition wall 46 provided therein. An inner diameter of the first housing chamber 45a is larger than an inner diameter of the second housing chamber 45b.

A through hole through which the shaft member 68A is inserted is formed at the center of the partition wall 46 between the first housing chamber 45a and the second housing chamber 45b. The shaft member 68A is arranged across the first housing chamber 45a and the second housing chamber 45b. The first housing chamber 45a houses the opening/closing mechanism 55, the moving part 62A, and a first biasing member 75a that constitutes the biasing part 75A. The second housing chamber 45b houses a second biasing member 75b that constitutes the biasing part 75A.

As shown in FIGS. 2 and 3, the cylindrical member 42A is provided with a groove 50A for controlling movement of the shaft member 68A within the cylindrical member 42A. The groove 50A passes through a side wall of the cylindrical member 42A. The groove 50A is formed in a substantially L-shape and has a first groove portion 51A extending in a circumferential direction of the cylindrical member 42A and a second groove portion 52A extending upward from an end of the first groove portion 51A. The groove 50A constitutes a part of the biasing force control mechanism 90A. Details of the function of the groove 50A are described later.

### Opening/Closing Mechanism

In FIGS. 2 and 4, the opening/closing mechanism 55 is shown in a closed state. In FIG. 3, the opening/closing mechanism 55 is shown in an exploded view. In FIG. 4, for convenience, the opening/closing mechanism 55 is shown not in a cross-sectional view, but in a schematic external view when facing in a direction of a rotation axis of the opening/closing mechanism 55.

As shown in FIG. 3, the opening/closing mechanism 55 includes a pair of rotating members 56, a pivot shaft member 57, and an opening/closing control member 58. As shown in FIG. 4, the rotating members 56 are connected by the pivot shaft member 57, which is configured by a shaft-like member and inserted through central parts of the rotating members 56. The opening/closing mechanism 55 is opened and closed by the rotating members 56 being rotated around the pivot shaft member 57 in opposite directions to each other. In this embodiment, the opening/closing direction of the opening/closing mechanism 55 is a front-rear direction.

Both ends of the pivot shaft member 57 are inserted through shaft holes 47 formed in a lower end part of the cylindrical member 42A. Accordingly, the opening/closing mechanism 55 is held in the lower end part of the cylindrical member 42A. As shown in FIGS. 2 and 4, the opening/closing mechanism 55 is held with its lower end part protruding toward the inside of the tool mounting part 43 from the lower end opening of the cylindrical member 42A.

The claws 59 are respectively formed on the lower ends of the rotating members 56 and extend outward in the opening/closing direction of the opening/closing mechanism 55. As shown in FIGS. 2 and 4, in the closed state of the opening/closing mechanism 55, flat back surfaces of the claws 59 are in surface contact with each other in the opening/closing direction. Each of the claws 59 has a semicircular bottom surface facing downward. In the closed state of the opening/closing mechanism 55, as shown in FIG. 2, the bottom surfaces of the claws 59 are adjacent to each other in the opening/closing direction to form a generally circular bottom surface.

A slit-like through groove 60 is formed in an upper end part of each of the rotating members 56 above the pivot shaft member 57. The through groove 60 extends obliquely upward from above the pivot shaft member 57 in a direction opposite to a protruding direction of the claws 59.

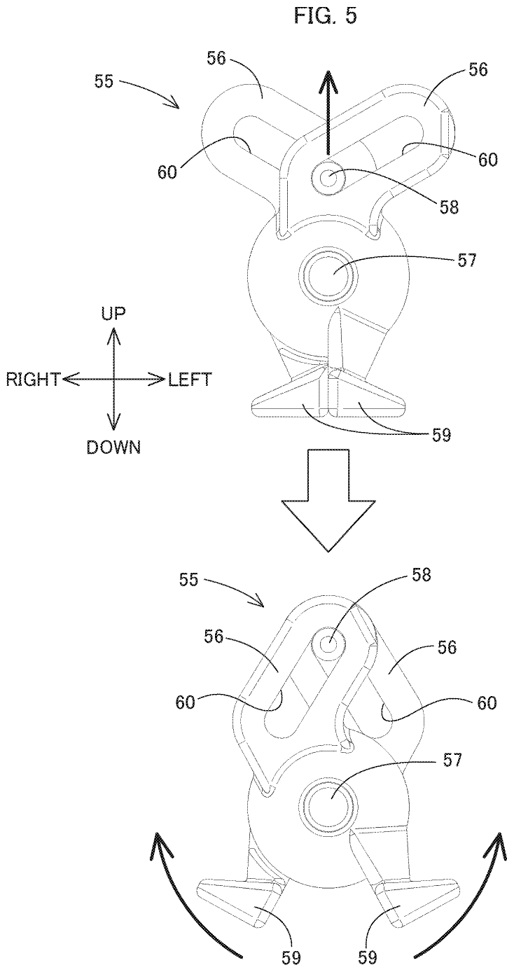

As shown in FIG. 3, the opening/closing control member 58 is configured by a shaft-like member. As shown in FIG. 4, the opening/closing control member 58 is arranged to be inserted through the through grooves 60 of the rotating members 56 at a position where the through grooves 60 cross each other. The opening/closing control member 58 is moved within the through grooves 60 of the rotating members 56 in order to open and close the opening/closing mechanism 55. The opening/closing operation of the opening/closing mechanism 55 is described later in more detail with reference to FIG. 5.

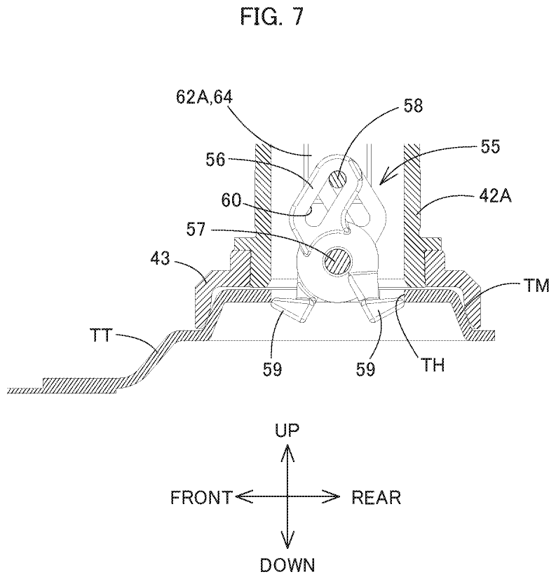

In the closed state, the opening/closing mechanism 55 can be inserted into a mounting hole TH of the tool accessory TT so that the tool accessory TT can be attached and detached. When the opening/closing mechanism 55 is in the open state, the claws 59 move away from each other in the opening/closing direction and are locked to a peripheral edge part of the mounting hole TH, so that the tool accessory TT is fixed. The state in which the tool accessory TT is fixed by the opening/closing mechanism 55 is described later in more detail with reference to FIG. 7.

### Moving Part

The moving part 62A is configured by a member having a tubular portion 63 through which the shaft member 68A is inserted. The moving part 62A is connected to one end of the shaft member 68A at the tubular portion 63. In this embodiment, the moving part 62A is connected to a lower end part of the shaft member 68A.

The moving part 62A has a circumferential groove 63g that passes through a side wall of the tubular portion 63 and extends in a circumferential direction. The circumferential grooves 63g are formed at two positions facing each other in a diametrical direction of the tubular portion 63. The moving part 62A is connected to the lower end part of the shaft member 68A by inserting projections 70 (described below) provided at the lower end part of the shaft member 68A into the circumferential grooves 63g.

The moving part 62A is housed in the cylindrical member 42A so as to be displaceable in a downward direction corresponding to a first direction and in an upward direction corresponding to a second direction opposite to the first direction. Since the moving part 62A is connected to the shaft member 68A as described above, the moving part 62A moves together with the shaft member 68A within the cylindrical member 42A.

The moving part 62A is arranged above the claws 59 of the opening/closing mechanism 55. The moving part 62A is connected to the opening/closing mechanism 55 in a state in which movement in the up-down direction relative to the opening/closing mechanism 55 is allowed. The moving part 62A has an extending end portion 64 in which a part of the side wall of the tubular portion 63 extends downward below the tubular portion 63. The moving part 62A has support holes 65 in the extending end portion 64 through which both ends of the opening/closing control member 58 of the opening/closing mechanism 55 are inserted. The moving part 62A is connected to the opening/closing mechanism 55 by the both ends of the opening/closing control member 58 being inserted into the support holes 65.

When the moving part 62A moves in the up-down direction relative to the opening/closing mechanism 55, the opening/closing control member 58 also moves in the up-down direction. Accordingly, the opening/closing mechanism 55 operates in a closing direction when the moving part 62A moves downward, and the opening/closing mechanism 55 operates in an opening direction when the moving part 62A moves upward.

### Shaft Member

Referring to FIGS. 3 and 4, the shaft member 68A is configured by a metallic columnar member. As described above, the shaft member 68A is housed within the cylindrical member 42A. A center axis of the shaft member 68A coincides with the center axis CX of the cylindrical member 42A. The shaft member 68A is arranged within the cylindrical member 42A so as to be rotatable in a rotating direction RD about the center axis CX relative to the cylindrical member 42A.

A first biasing member 75a and a second biasing member 75b that constitute the biasing part 75A are arranged around the shaft member 68A. The shaft member 68A guides elastic deformation (contraction and extension) of the first biasing member 75a and the second biasing member 75b. The shaft member 68A is held within the cylindrical member 42A so as to be movable in the up-down direction while directly or indirectly receiving biasing force from the first biasing member 75a and the second biasing member 75b.

Projections 70 protruding toward the cylindrical member 42A are formed at a lower end part of the shaft member 68A. In this embodiment, the projections 70 are configured by a shaft-like member that is attached so as to pass through the lower end part of the shaft member 68A orthogonally to the center axis of the shaft member 68A. The projections 70 protrude to both sides in a radial direction of the shaft member 68A.

A moving part 62A is connected to one end of the shaft member 68A. As described above, the shaft member 68A is connected to the moving part 62A by the projections 70 being inserted into circumferential grooves 63g of the moving part 62A, and is movable together with the moving part 62A in the up-down direction relative to the opening/closing mechanism 55. A circumferential direction in which the circumferential grooves 63g extend coincides with the rotating direction RD of the shaft member 68A. The shaft member 68A is allowed to rotate in the rotating direction RD relative to the moving part 62A within a range in which the projections 70 can move along the circumferential grooves 63g.

The projections 70 of the shaft member 68A pass through the circumferential grooves 63g of the moving part 62A and through holes 80 of a cylindrical moving body 77 (described below) and are inserted into the grooves 50A of the cylindrical member 42A. The projections 70 are movable along the grooves 50A. An operation by cooperation of the projections 70 and the grooves 50A will be described later.

As shown in FIG. 3, a substantially disc-like shaft end part 72 having a larger diameter than other parts of the shaft member 68A is provided at an upper end part of the shaft member 68A. As shown in FIG. 4, the shaft end part 72 has a size to be fitted into a cylinder hole of the cylindrical member 42A. A lower surface of the shaft end part 72 abuts against an end part of the second biasing member 75b arranged in the second housing chamber 45b and receives upward biasing force from the second biasing member 75b.

A lever abutment part 89A that constitutes a tool detaching mechanism 85A is provided on an upper surface of the shaft end part 72. In a state in which the opening/closing mechanism 55 is closed, as shown in FIG. 4, the lever abutment part 89A is located at a position where it does not contact a lever mounting shaft 87 of a lever member 86 of the tool detaching mechanism 85A. In a state in which the opening/closing mechanism 55 is open, the lever abutment part 89A abuts against the lever mounting shaft 87 of the lever member 86. A configuration and a function of the lever abutment part 89A will be described later.

### Biasing Part

The biasing part 75A generates a biasing force for operating the mounting mechanism 40A. The biasing part 75A includes a first biasing member 75a and a second biasing member 75b, and generates the aforementioned biasing force by these two biasing members 75a and 75b. In this embodiment, the first biasing member 75a and the second biasing member 75b are configured by compression springs and are arranged around the outer periphery of the shaft member 68A as described above. An elastic modulus of the second biasing member 75b is larger than that of the first biasing member 75a.

As described above, the first biasing member 75a is arranged in the first housing chamber 45a of the cylindrical member 42A. The first biasing member 75a is arranged in the first housing chamber 45a in a state of being compressed from a natural length in an unloaded state, with one end in contact with the partition wall 46 and the other end in contact with the cylindrical moving body 77. The first biasing member 75a applies a downward biasing force to the cylindrical moving body 77. The cylindrical moving body 77 is arranged at the lowest position within a movable range by the biasing force of the first biasing member 75a.

As described above, the second biasing member 75b is arranged in the second housing chamber 45b of the cylindrical member 42A. The second biasing member 75b is arranged in the second housing chamber 45b in a state of being compressed from a natural length in an unloaded state, with one end in contact with the lower surface of the shaft end part 72 of the shaft member 68A and the other end in contact with the upper wall surface of the partition wall 46. The second biasing member 75b biases the shaft member 68A upward by an upward biasing force.

### Cylindrical Moving Body

As shown in FIG. 3, the cylindrical moving body 77 is configured by a cylindrical member having a diameter larger than that of the cylindrical part 63 of the moving part 62A. The cylindrical moving body 77 has a diameter such that an outer peripheral wall surface thereof is close to an inner wall surface of the second accommodation chamber 45b.

As shown in FIG. 4, the cylindrical moving body 77 is arranged on an outer periphery of the moving part 62A. Further, the opening/closing mechanism 55 is arranged in an internal space of the cylindrical moving body 77. In a state in which the opening/closing mechanism 55 is closed, the claws 59 of the opening/closing mechanism 55 protrude from a lower end of the cylindrical moving body 77. A through window 78 for avoiding interference with the opening/closing mechanism 55 that performs an opening/closing operation is formed in a side wall of the cylindrical moving body 77.

As shown in FIG. 3, a longitudinal groove 79 extending in the up-down direction is provided at a lower end part of the cylindrical moving body 77. The longitudinal groove 79 is provided so as to pass through the side wall of the cylindrical moving body 77. Two longitudinal grooves 79 facing each other in a radial direction of the cylindrical moving body 77 are formed in the cylindrical moving body 77.

Both ends of the pivot shaft member 57 of the opening/closing mechanism 55 are inserted into the two longitudinal grooves 79. Accordingly, the cylindrical moving body 77 is in a state of being connected to the opening/closing mechanism 55. Further, the cylindrical moving body 77 is in a state in which movement in the up-down direction relative to the opening/closing mechanism 55 is allowed by a length of the longitudinal grooves 79.

Through holes 80 into which the projections 70 of the shaft member 68A are inserted are formed in the side wall constituting an upper end part of the cylindrical moving body 77. Two through holes 80 facing each other in the radial direction of the cylindrical moving body 77 are formed in the cylindrical moving body 77. The through holes 80 are provided above the longitudinal grooves 79. The cylindrical moving body 77 rotates the shaft member 68A in the rotating direction RD by bringing an inner wall surface of each through hole 80 into abutment with the protruding part 70. A function of the cylindrical moving body 77 will be described later.

### Tool Detaching Mechanism

The tool detaching mechanism 85A is a mechanism for releasing a fixed state of a tool accessory TT with respect to the tool mounting part 43 in order to enable removal of the tool accessory TT from the mounting mechanism 40A. The tool detaching mechanism 85A includes a lever member 86 arranged at an upper end part of the cylindrical member 42A, a lever mounting shaft 87 attached to the lever member 86, and a lever biasing member 88 that biases the lever member 86. Further, the tool detaching mechanism 85A includes the aforementioned lever abutment part 89A provided at the shaft end part 72 of the shaft member 68A. The lever biasing member 88 is illustrated only in FIG. 3 and is omitted in FIGS. 2 and 4.

The lever member 86 includes a finger-hooking part 86a on which a user places a finger, a disc-like disc part 86b to which the finger-hooking part 86a is connected, and a cylindrical circumferential wall part 86c extending downward from the disc part 86b. The lever member 86 is arranged such that the circumferential wall part 86c surrounds an outer periphery of the upper end part of the cylindrical member 42A.

The lever mounting shaft 87 is a shaft-like member attached to the lever member 86. The lever mounting shaft 87 is held by the lever member 86 by intersecting a center axis of the disc part 86b and passing through the circumferential wall part 86c in a radial direction.

The lever biasing member 88 is configured by a torsion spring and is arranged on an outer periphery of the circumferential wall part 86c. The lever biasing member 88 biases the lever member 86 rotated by the user in a direction to return the lever member 86 to its original position. A configuration of the lever abutment part 89A will be described later.

When the lever member 86 is rotated about the center axis of the disc part 86b, the lever mounting shaft 87 and the lever abutment part 89A abut against each other to move the shaft member 68A downward and rotate the shaft member 68A in the rotating direction RD. By this movement and rotation of the shaft member 68A, the fixation of the tool accessory TT is released, and removal of the tool accessory TT becomes possible. A mechanism by which the fixation of the tool accessory TT is released by the tool detaching mechanism 85A will be described after a description of a biasing force control mechanism 90A in the mounting mechanism 40A.

### 1-3. Operation of the Opening/Closing Mechanism

The upper part of FIG. 5 illustrates the opening/closing mechanism 55 in a closed state, and the lower part of FIG. 5 illustrates the opening/closing mechanism 55 in an open state.

In the state in which the opening/closing mechanism 55 is closed, the opening/closing control member 58 is located at a lower end of each of the through grooves 60 of the pair of rotating members 56 and is arranged at a position closest to the pivot shaft member 57. When the opening/closing control member 58 is moved upward relative to the pivot shaft member 57 from this closed state, the opening/closing control member 58 slides within the through grooves 60 along inner wall surfaces of the through grooves 60, and each rotating member 56 rotates about the pivot shaft member 57 as a pivot. Accordingly, the claws 59 at the lower ends of the respective rotating members 56 rotate in directions away from each other, so that the opening/closing mechanism 55 enters the open state.

As described with reference to FIGS. 3 and 4, the opening/closing control member 58 is supported by the support holes 65 at the lower end part of the moving part 62A. The opening/closing control member 58 is displaced relative to the pivot shaft member 57 together with the moving part 62A. Therefore, the opening/closing mechanism 55 operates in a closing direction when the moving part 62A moves downward, and the opening/closing mechanism 55 operates in an opening direction when the moving part 62A moves upward. Thus, by controlling the movement of the moving part 62A within the cylindrical member 42A, the opening/closing operation of the opening/closing mechanism 55 can be controlled.

### 1-4. Operation of the Biasing Force Control Mechanism

In the mounting mechanism 40A, movement of the moving part 62A for opening and closing the opening/closing mechanism 55 is controlled by the biasing force control mechanism 90A switching a state in which a biasing force of the biasing part 75A acts. The biasing force control mechanism 90A is configured by at least the aforementioned cylindrical member 42A, shaft member 68A, and biasing part 75A. In this embodiment, the cylindrical moving body 77 functions as one component of the biasing force control mechanism 90A. The biasing force control mechanism 90A is configured to switch the state in which the biasing force of the biasing part 75A acts by cooperating these components between when the opening/closing mechanism 55 is in the closed state and when the opening/closing mechanism 55 opens.

First, the action of the biasing force of the biasing part 75A in the state in which the opening/closing mechanism 55 is closed will be described with reference to FIGS. 2 and 4. In the state in which the opening/closing mechanism 55 is closed, the biasing force control mechanism 90A causes the biasing force of the biasing part 75A to act such that the closed state of the opening/closing mechanism 55 is maintained. In this embodiment, in the state in which the opening/closing mechanism 55 is closed, the biasing force control mechanism 90A brings about a state in which the biasing force of the first biasing member 75a acts on the cylindrical moving body 77 and the biasing force of the second biasing member 75b does not act on the moving part 62A.

As described above, in the state in which the opening/closing mechanism 55 is closed, the cylindrical moving body 77 is biased downward by the first biasing member 75a and is kept in a state of being located at the lowest position within a range in which the cylindrical moving body 77 is movable in the up-down direction. As described later, in the mounting mechanism 40A, when the cylindrical moving body 77 moves upward relative to the opening/closing mechanism 55, the opening/closing mechanism 55 enters a state of operating in an opening direction. That is, it can be interpreted that, in the state in which the opening/closing mechanism 55 is closed, the biasing force of the first biasing member 75a, which acts in a direction to suppress the upward movement of the cylindrical moving body 77, acts so as to maintain the closed state of the opening/closing mechanism 55.

A biasing force of the second biasing member 75b in the state in which the opening/closing mechanism 55 is closed will be described. As described above, the biasing force of the second biasing member 75b is applied to the shaft member 68A. However, as described below, the biasing force of the second biasing member 75b does not act so as to move the moving part 62A because movement of the shaft member 68A is restricted.

The biasing force control mechanism 90A is configured such that the projections 70 of the shaft member 68A are located in the first groove portions 51A of the grooves 50A of the cylindrical member 42A in the state in which the opening/closing mechanism 55 is closed. As described above, the first groove portions 51A extend in a circumferential direction of the cylindrical member 42A, that is, in the rotating direction RD of the shaft member 68A, and extend in a direction orthogonal to the up-down direction.

When the projections 70 are located in the first groove portions 51A, the projections 70 are locked in the up-down direction relative to inner wall surfaces of the first groove portions 51A, so that movement of the projections 70 in the up-down direction is restricted. The first groove portion 51A is a “restricted region” in which movement of the protruding part 70 in the second direction is restricted.

In the state in which the opening/closing mechanism 55 is closed, the shaft member 68A is in a state of being locked upward relative to the cylindrical member 42A at the projections 70, and upward movement thereof is restricted. Therefore, the biasing force of the second biasing member 75b enters a state of not acting.

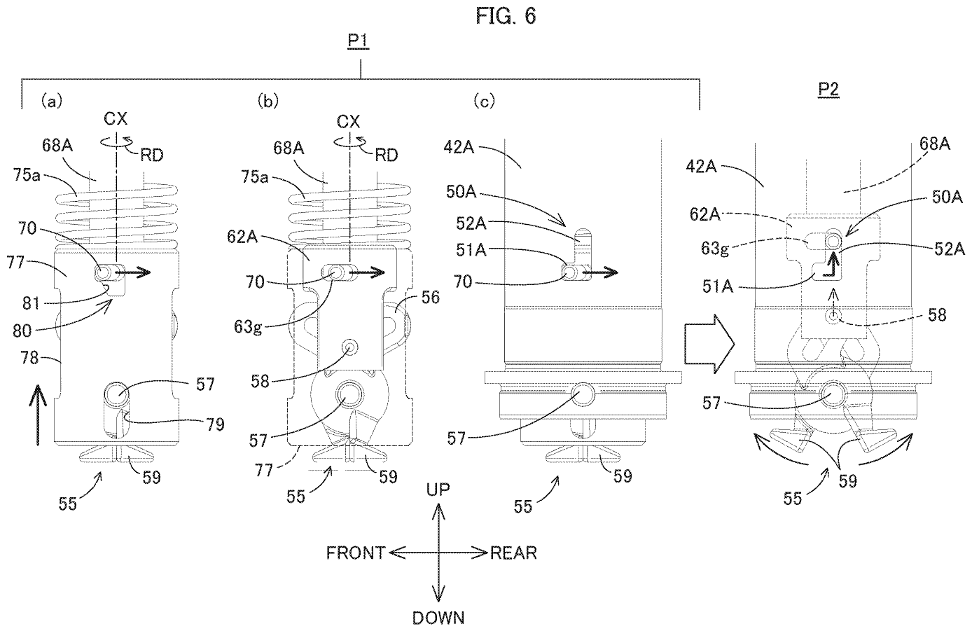

Next, a mechanism by which the opening/closing mechanism 55 operates from the closed state to the open state by the biasing force control mechanism 90A switching the state in which the biasing force of the biasing part 75A acts will be described with reference to FIGS. 4 and 6. As described below, the biasing force control mechanism 90A causes the biasing force to act on the shaft member 68A in a direction in which the moving part 62A moves upward to open the opening/closing mechanism 55 by changing a state in which the shaft member 68A is locked relative to the cylindrical member 42A.

First, a process of mounting a tool accessory TT to the opening/closing mechanism 55 in the closed state will be described with reference to FIG. 4. As described above, the tool accessory TT has a mounting part TM that fits with the tool mounting part 43. The mounting part TM has a mounting hole TH through which the claws 59 of the opening/closing mechanism 55 in the closed state can be inserted.

When the mounting part TM of the tool accessory TT is positioned relative to the tool mounting part 43 and the tool accessory TT is moved upward toward the tool mounting part 43 so that the mounting part TM fits with the tool mounting part 43, the lower ends of the claws 59 enter the mounting hole TH of the mounting part TM. Further, a peripheral edge part of the mounting hole TH comes into contact with the lower end of the cylindrical moving body 77 protruding around the claws 59.

As described above, the cylindrical moving body 77 is biased downward by the first biasing member 75a. An external force opposing the biasing force of the first biasing member 75a is applied by the peripheral edge part of the mounting hole TH of the tool accessory TT, and when the external force becomes larger than the biasing force of the first biasing member 75a, the cylindrical moving body 77 can be moved upward.

Referring to FIG. 6, an operation process P1 in which the state in which the biasing force of the biasing part 75A acts is switched, and an operation process P2 in which the opening/closing mechanism 55 opens are illustrated. Column (a) of FIG. 6 illustrates the operation of the cylindrical moving body 77 in the operation process P1, and column (b) of FIG. 6 illustrates the operation of the moving part 62A within the cylindrical moving body 77 in the operation process P1. Further, column (c) of FIG. 6 illustrates the operation of the protruding part 70 in the groove 50A of the cylindrical member 42A in the operation process P1. In FIG. 6, for convenience, the tool mounting part 43 of the cylindrical member 42A is omitted.

Referring to column (a) of FIG. 6, as described above, the through hole 80 into which the protruding part 70 of the shaft member 68A is inserted is formed at the upper end part of the cylindrical moving body 77. The through hole 80 has an inclined wall surface 81 that is inclined relative to the rotating direction RD of the shaft member 68A. The inclined wall surface 81 is inclined from an upper end toward a lower end thereof so as to approach the second groove portion 52A of the groove 50A of the cylindrical member 42A. The biasing force control mechanism 90A is configured such that, in the state in which the opening/closing mechanism 55 is closed, the protruding part 70 of the shaft member 68A is in a state of being locked at the upper end of the inclined wall surface 81.

When a predetermined external force is applied from a tool accessory TT to be mounted to the opening/closing mechanism 55 to the lower end part of the cylindrical moving body 77, the cylindrical moving body 77 starts moving upward. Then, as shown in column (a) of FIG. 6, the protruding part 70 of the shaft member 68A is pushed sideways by the inclined wall surface 81, so that the shaft member 68A rotates in the rotating direction RD.

At this time, as shown in column (b) of FIG. 6, the protruding part 70 of the shaft member 68A is inserted in the circumferential groove 63g of the moving part 62A, and thus rotation of the shaft member 68A is not restricted by the moving part 62A. Further, as shown in column (c) of FIG. 6, since the protruding part 70 is located in the first groove portion 51A in the groove 50A of the cylindrical member 42A, movement in the rotating direction RD is allowed. Accordingly, rotation of the shaft member 68A is not restricted by the groove 50A of the cylindrical member 42A.

When the protruding part 70 pushed by the inclined wall surface 81 of the through hole 80 of the cylindrical moving body 77 is located at the lower end of the inclined wall surface 81, the protruding part 70 reaches the lower end of the second groove portion 52A in the groove 50A of the cylindrical member 42A. The second groove portion 52A extends upward from an end of the first groove portion 51A. Therefore, upward movement of the protruding part 70 is allowed in the second groove portion 52A. The second groove portion 52A is an “allowed region” in which the upward movement of the protruding part 70 is allowed.

As described above, the shaft member 68A is biased by an upward biasing force by the second biasing member 75b. When the protruding part 70 of the shaft member 68A reaches the second groove portion 52A of the groove 50A of the cylindrical member 42A, the state in which the shaft member 68A is locked upward relative to the cylindrical member 42A at the protruding part 70 is released, and the restriction on the upward movement of the shaft member 68A is released. Accordingly, the shaft member 68A starts moving upward by the action of the biasing force of the second biasing member 75b (operation process P2). Since the moving part 62A is connected to the shaft member 68A, the moving part 62A moves upward together with the shaft member 68A. As a result, the opening/closing mechanism 55 operates in the opening direction.

Referring to FIG. 7, when the opening/closing mechanism 55 opens with the tool accessory TT mounted, the claws 59 of the opening/closing mechanism 55 are in a state of being locked to the peripheral edge part of the mounting hole TH. The tool accessory TT is in a state of being sandwiched in the up-down direction between the tool mounting part 43 and the claws 59 of the opening/closing mechanism 55, and is fixed to the tool mounting part 43. The moving part 62A is in a state of being biased upward by the second biasing member 75b via the shaft member 68A; since it is biased upward, the opening/closing mechanism 55 is maintained in the open state.

### 1-5. Operation of the Tool Detaching Mechanism

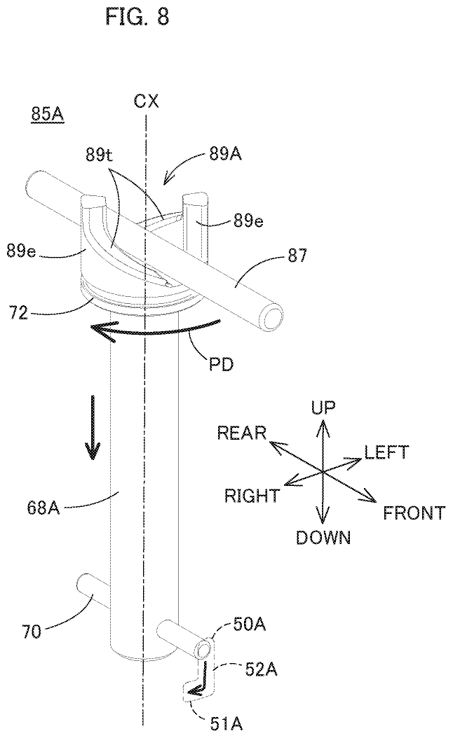

Referring to FIG. 8, the lever mounting shaft 87 and the shaft member 68A in the mounting mechanism 40A in a state in which the opening/closing mechanism 55 is open are extracted and illustrated. Further, in FIG. 8, the groove 50A of the cylindrical member 42A is illustrated by a broken line.

In the state in which the opening/closing mechanism 55 is open, the lever abutment part 89A provided at the shaft end part 72 of the shaft member 68A is in a state of abutting against the lever mounting shaft 87. The lever mounting shaft 87 is arranged at a lower end of an extending wall portion 89e extending upward from the shaft end part 72. In the state in which the opening/closing mechanism 55 is open, the projections 70 of the shaft member 68A are located at the upper ends of the second groove portions 52A of the grooves 50A of the cylindrical member 42A.

The extending wall portion 89e has an inclined upper end surface 89t that becomes higher toward a lever rotating direction PD, which is a direction in which the lever member 86 is rotated to release the fixed state of the tool accessory TT. When the lever member 86 is rotated in the lever rotating direction PD to release the fixed state of the tool accessory TT, the lever mounting shaft 87 rotates together with the lever member 86 about the center axis CX and rides up on the inclined upper end surface 89t.

While the projections 70 are located in the second groove portions 52A of the grooves 50A, the shaft member 68A is in a state in which rotation about the center axis CX is restricted. Therefore, only a force of the lever mounting shaft 87 pushing the inclined upper end surface 89t downward acts effectively, and the shaft member 68A moves downward. When the shaft member 68A moves downward, the moving part 62A moves downward together with the shaft member 68A, so that the opening/closing mechanism 55 operates in the closing direction.

When the projections 70 reach the ends of the first groove portions 51A of the grooves 50A by the force of the lever mounting shaft 87 pushing the inclined upper end surface 89t downward, the opening/closing mechanism 55 enters a completely closed state. When the projections 70 are located in the first groove portions 51A, the projections 70 are allowed to move in the lever rotating direction PD. Therefore, by the force of the lever mounting shaft 87 pushing the inclined upper end surface 89t, the shaft member 68A rotates in the lever rotating direction PD, and the projections 70 move to the ends of the first groove portions 51A. As a result, the biasing force of the second biasing member 75b enters a state of not acting on the shaft member 68A, and the closed state of the opening/closing mechanism 55 is maintained.

According to the tool detaching mechanism 85A of the mounting mechanism 40A, the movement of the shaft member 68A in the second direction and the rotation in the lever rotating direction PD can be controlled by cooperation of the lever mounting shaft 87, the lever abutment part 89A, the projections 70, and the grooves 50A. Therefore, the fixed state of the tool accessory TT can be easily released only by a rotation operation of the lever member 86.

### 1-6. Summary of the First Embodiment

As described above, according to the power tool 10 of the first embodiment, the closed state of the opening/closing mechanism 55 can be maintained by the biasing force caused to act by the biasing force control mechanism 90A. Further, when a predetermined external force is applied from a tool accessory TT in the state in which the opening/closing mechanism 55 is closed, the biasing force control mechanism 90A switches the state in which the biasing force acts by changing a locked state of the shaft member 68A relative to the cylindrical member 42A. Accordingly, the opening/closing mechanism 55 can be operated in the opening direction, and the tool accessory TT can be fixed. According to the configuration of the first embodiment, the tool accessory TT can be mounted to the power tool 10 by a simple one-touch operation of only applying an external force via the tool accessory TT.

According to the configuration of the first embodiment, switching of the state in which the biasing force acts can be easily realized by a mechanism capable of restricting movement of the shaft member 68A by locking the shaft member 68A relative to the cylindrical member 42A. Further, according to the configuration of the first embodiment, a configuration capable of controlling the restriction of the movement of the shaft member 68A by rotation of the shaft member 68A can be easily realized by cooperation of the projections 70 of the shaft member 68A and the grooves 50A of the cylindrical member 42A. According to the configuration of the first embodiment, a configuration for rotating the shaft member 68A in order to switch the state in which the biasing force acts when a predetermined external force is applied from the tool accessory TT can be realized by a simple configuration in which the projections 70 of the shaft member 68A and the through holes 80 of the cylindrical moving body 77 cooperate with each other.

### 2. Second Embodiment

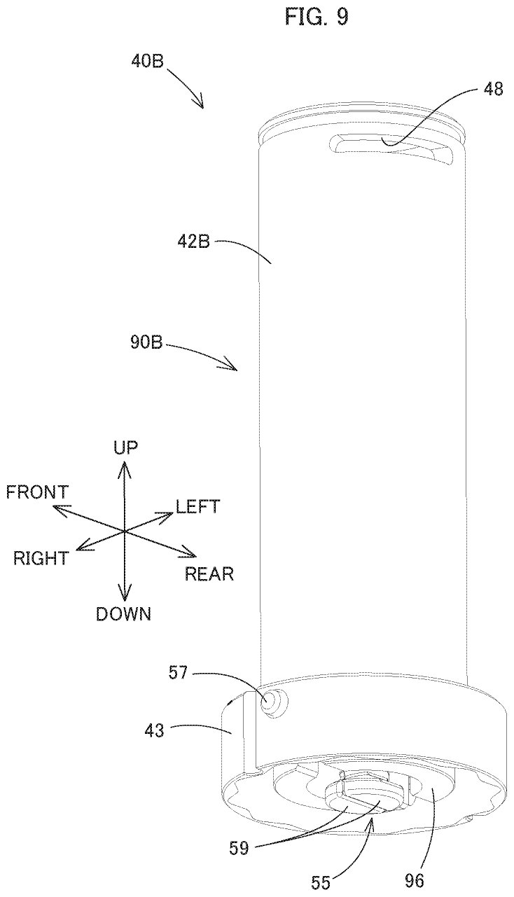

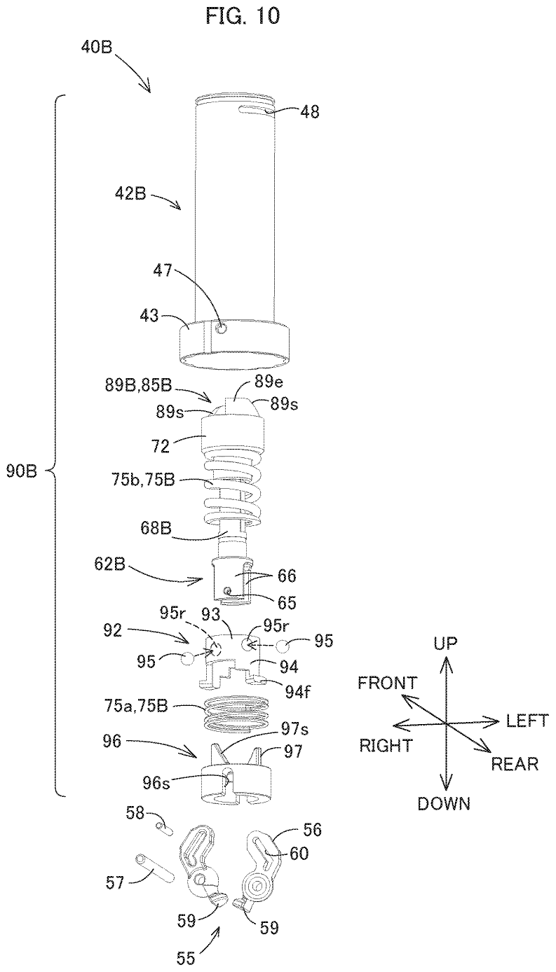

A configuration of a mounting mechanism 40B of a power tool according to a second embodiment will be described with reference to FIGS. 9 to 13. The configuration of the power tool of the second embodiment is substantially the same as that of the power tool 10 of the first embodiment, except that the configuration of the mounting mechanism 40B is different. The configuration of the mounting mechanism 40B of the second embodiment is basically the same as the configuration of the mounting mechanism 40A of the first embodiment unless otherwise described below.

### 2-1. Components of the Mounting Mechanism

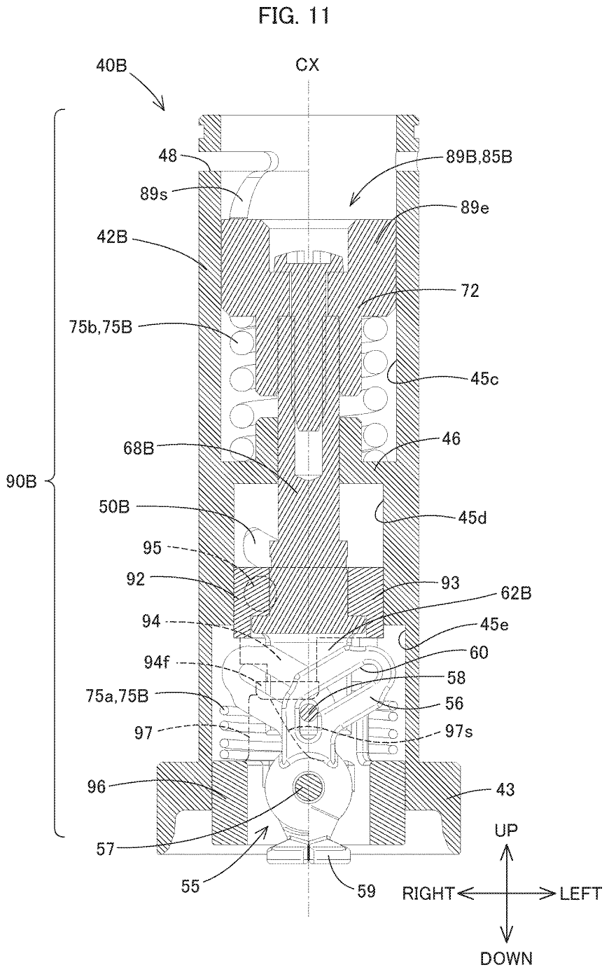

Components of the mounting mechanism 40B of the second embodiment will be described with reference to FIGS. 9 to 12 as appropriate. FIGS. 9 and 11 illustrate the opening/closing mechanism 55 in the closed state. The mounting mechanism 40B includes the opening/closing mechanism 55, a cylindrical member 42B, a shaft member 68B, a moving part 62B, a rotating member 92, a side moving body 96, a biasing part 75B, and a tool detaching mechanism 85B. Since the configuration of the opening/closing mechanism 55 is substantially the same as that of the first embodiment, a detailed description thereof is omitted.

### Cylindrical Member

Similarly to the cylindrical member 42A of the first embodiment, the cylindrical member 42B of the second embodiment is a cylindrical metal member and configures a housing of the mounting mechanism 40B. The cylindrical member 42B surrounds an outer periphery of the shaft member 68B and accommodates the moving part 62B.

The tool mounting part 43 is provided at a lower end of the cylindrical member 42B. The shaft holes 47 are formed in the tool mounting part 43 and support both ends of the pivot shaft member 57 of the opening/closing mechanism 55. As shown in FIG. 11, lower ends of the claws 59 of the opening/closing mechanism 55 in the closed state slightly protrude downward from an opening of the tool mounting part 43. The claws 59 of the opening/closing mechanism 55 open and close within the tool mounting part 43. Further, as shown in FIG. 11, in the state in which the opening/closing mechanism 55 is closed, a lower end part of a side moving body 96, which will be described later, protrudes into the tool mounting part 43.

As shown in FIG. 11, an inner space of the cylindrical member 42B above the tool mounting part 43 is partitioned into three spaces arranged in the up-down direction. The inner space of the cylindrical member 42B is partitioned into an upper accommodation chamber 45c, a middle accommodation chamber 45d, and a lower accommodation chamber 45e in this order from above. The upper accommodation chamber 45c and the middle accommodation chamber 45d are partitioned by a partition wall 46. A through hole through which the shaft member 68B is inserted is formed at a center of the partition wall 46. Inner diameters of the upper accommodation chamber 45c and the lower accommodation chamber 45e are larger than an inner diameter of the middle accommodation chamber 45d.

The upper accommodation chamber 45c accommodates an upper part of the shaft member 68B and a second biasing member 75b configuring the biasing part 75B. A side wall surface of the upper accommodation chamber 45c is close to an outer peripheral side wall surface of the shaft end part 72 configuring an upper end part of the shaft member 68B. A diameter of the shaft end part 72 is larger than diameters of other parts of the shaft member 68B. The second biasing member 75b is installed such that one end thereof is in contact with a lower surface of the shaft end part 72 and the other end thereof is in contact with an upper wall surface of the partition wall 46.

A lateral groove 48 is formed through a side wall of the cylindrical member 42B at an upper end part of the upper accommodation chamber 45c and extends in a circumferential direction of the cylindrical member 42B. Both end parts of the lever mounting shaft 87 described in the first embodiment are inserted through the lateral groove 48. In FIGS. 9 to 11, illustration of the lever mounting shaft 87 is omitted. The lateral groove 48 supports the lever mounting shaft 87 so as to allow the lever mounting shaft 87 to rotate about the center axis CX.

No partition wall is formed between the middle accommodation chamber 45d and the lower accommodation chamber 45e. A lower part of the shaft member 68B is arranged across the middle accommodation chamber 45d and the lower accommodation chamber 45e. As will be described later, the lower end part of the shaft member 68B configures the moving part 62B. The moving part 62B is arranged to move in the up-down direction at a boundary between the middle accommodation chamber 45d and the lower accommodation chamber 45e.

A rotating member 92, which will be described later, is attached to an outer periphery of the lower part of the shaft member 68B. The rotating member 92 is arranged on the moving part 62B. The rotating member 92 moves in the up-down direction together with the shaft member 68B at the boundary between the middle accommodation chamber 45d and the lower accommodation chamber 45e. An inner wall surface of the middle accommodation chamber 45d is close to an outer peripheral side surface of an upper cylindrical part 93 of the rotating member 92.

In the inner wall surface of the middle accommodation chamber 45d, a groove 50B is formed which accommodates a convex part 95, which will be described later, provided on an outer peripheral surface of the rotating member 92 and defines a moving path of the convex part 95. The groove 50B will be described later.

The lower accommodation chamber 45e accommodates a part of the opening/closing mechanism 55 located above the pivot shaft member 57. Further, a downward extending part 94 of the rotating member 92, which will be described later, is arranged in the lower accommodation chamber 45e. In FIG. 11, the downward extending part 94 is illustrated by a broken line.

The lower accommodation chamber 45e accommodates a first biasing member 75a configuring the biasing part 75B. An upper end of the first biasing member 75a is in abutment with a lower end of the downward extending part 94. Further, a lower end of the first biasing member 75a is in abutment with an upper surface of the side moving body 96. The first biasing member 75a biases the rotating member 92 upward and biases the side moving body 96 downward.

### Shaft Member

As described above, the shaft member 68B is arranged across the upper accommodation chamber 45c, the middle accommodation chamber 45d, and the lower accommodation chamber 45e of the cylindrical member 42B. The shaft member 68B is arranged within the cylindrical member 42B so as to be movable in the up-down direction relative to the cylindrical member 42B.

In the second embodiment, the moving part 62B is integral with the shaft member 68B and configures a lower end part of the shaft member 68B. The moving part 62B can also be interpreted as being connected to one end of the shaft member 68B. As will be described later, the shaft member 68B is connected to the opening/closing control member 58 of the opening/closing mechanism 55 at the moving part 62B, and is in a state in which rotation about the center axis CX relative to the cylindrical member 42B is restricted.

The shaft end part 72, which is also described in the first embodiment, is provided at an upper end part of the shaft member 68B. The shaft member 68B is held within the cylindrical member 42B in a state in which an upward biasing force is applied to a lower surface of the shaft end part 72 by the second biasing member 75b. A lever abutment part 89B, which is a component of the tool detaching mechanism 85B, is provided on an upper surface of the shaft end part 72. The lever abutment part 89B will be described in the section of the tool detaching mechanism 85B.

### Moving Part

As described above, the moving part 62B configures a lower end part of the shaft member 68B. The moving part 62B is configured by a pair of plate-like portions 66 extending in the up-down direction so as to sandwich a part of the opening/closing mechanism 55 located above the pivot shaft member 57.

The support holes 65 for connection with the opening/closing mechanism 55 are formed in the pair of plate-like portions 66 of the moving part 62B, respectively. The moving part 62B supports the opening/closing control member 58 by having both end parts of the opening/closing control member 58 inserted into the support holes 65. With this configuration, the moving part 62B can operate the opening/closing mechanism 55 in an opening direction when moving upward, and can operate the opening/closing mechanism 55 in a closing direction when moving downward.

### Rotating Member

The rotating member 92 includes a cylindrical upper cylindrical part 93 and a pair of downward extending parts 94 extending downward from a lower end of the upper cylindrical part 93. The upper cylindrical part 93 is arranged at an outer periphery of the shaft member 68B above the moving part 62B so as to be rotatable in a rotating direction RD about the center axis CX relative to the shaft member 68B. The upper cylindrical part 93 is locked in a state of being sandwiched in the up-down direction by convex structures provided on the outer periphery of the shaft member 68B. Accordingly, the rotating member 92 is movable in the up-down direction together with the shaft member 68B.

Convex parts 95 are provided on an outer peripheral side surface of the upper cylindrical part 93. The convex parts 95 are provided at two positions facing each other across the center axis CX. The convex part 95 is configured by a spherical rolling member that rolls at a fixed position. The convex part 95 is fitted into a hemispherical recess 95r provided on the outer peripheral side surface of the upper cylindrical part 93 and rolls within the recess 95r. The convex part 95 is accommodated within a groove 50B provided on an inner wall surface of the middle accommodation chamber 45d of the cylindrical member 42B. A function of the convex part 95 will be described later.

The pair of downward extending parts 94 are respectively provided on a radially outer side of the moving part 62B and are arranged so as to sandwich the moving part 62B in the radial direction. As described above, a lower end of each downward extending part 94 is in abutment with an upper end of the first biasing member 75a arranged in the lower accommodation chamber 45e. Accordingly, the rotating member 92 is in a state of being biased upward by the first biasing member 75a.

At a lower end part of the downward extending part 94, an abutted part 94f is provided which extends in the radial direction toward an inner wall surface of the lower accommodation chamber 45e of the cylindrical member 42B. The abutted part 94f is a part with which an abutment part 97 of a side moving body 96, which will be described later, abuts when the side moving body 96 moves upward. When the abutment part 97 of the side moving body 96 abuts against the abutted part 94f, the rotating member 92 rotates in the rotating direction RD. The rotation operation of the rotating member 92 will be described later.

A radial tip end part of the abutment part 97 is close to the inner wall surface of the lower accommodation chamber 45e. Accordingly, the rotating member 92 can receive support in the radial direction from the inner wall surface of the lower accommodation chamber 45e. Therefore, a rotation posture of the rotating member 92 is more stabilized, and the rotation of the rotating member 92 is further smoothed.

### Side Moving Body

The side moving body 96 has a cylindrical shape. An inner space of the side moving body 96 accommodates a central part of the opening/closing mechanism 55 where the pivot shaft member 57 is provided. Side wall parts of the side moving body 96 are arranged at sides of the opening/closing mechanism 55.

The side moving body 96 is held at a lower end part of the cylindrical member 42B so as to be displaceable in the up-down direction relative to the opening/closing mechanism 55. Two slits 96s are formed in the side moving body 96 at positions facing each other across the center axis CX. The pivot shaft member 57 of the opening/closing mechanism 55 is inserted through the slits 96s. The slits 96s extend in the up-down direction from an upper end part to a lower end of the side moving body 96 such that the side moving body 96 can move in the up-down direction without the pivot shaft member 57 interfering therewith.

The side moving body 96 is arranged below the first biasing member 75a arranged in the lower accommodation chamber 45e. An upper end surface of a peripheral edge of an opening of the side moving body 96 configures a bottom surface of the lower accommodation chamber 45e and receives a downward biasing force from the first biasing member 75a. As shown in FIG. 11, in a state in which the opening/closing mechanism 55 is closed, the side moving body 96 is supported by the pivot shaft member 57 of the opening/closing mechanism 55 at upper end parts of the slits 96s while being biased downward by the first biasing member 75a. Hereinafter, this position of the side moving body 96 is also referred to as an “initial position.”

In the state in which the opening/closing mechanism 55 is closed and the side moving body 96 is in the initial position, a lower end part of the side moving body 96 is in a state of extending into an inside of the tool mounting part 43 at a side of the claws 59 of the opening/closing mechanism 55. As will be described later, when a tool accessory TT is mounted to the opening/closing mechanism 55 in the closed state, a peripheral edge part of a mounting hole TH of the tool accessory TT abuts against the lower end part of the side moving body 96.

The side moving body 96 has an abutment part 97 configured by a wall part extending upward from the upper end surface thereof. The abutment part 97 has an inclined end surface 97s that is inclined relative to the up-down direction and faces in a circumferential direction about the center axis CX. As will be described later, when the side moving body 96 moves upward, the inclined end surface 97s of the abutment part 97 abuts against the abutted part 94f of the rotating member 92, causing rotation of the rotating member 92 in the rotating direction RD.

### Biasing Part

The biasing part 75B generates a biasing force for controlling an opening/closing state of the opening/closing mechanism 55. The biasing part 75B is configured by a first biasing member 75a and a second biasing member 75b. The first biasing member 75a and the second biasing member 75b are configured by compression coil springs. As described above, the first biasing member 75a is arranged in the lower accommodation chamber 45e of the cylindrical member 42B. The second biasing member 75b is arranged at an outer periphery of the shaft member 68B in the upper accommodation chamber 45c. A spring constant of the second biasing member 75b is larger than a spring constant of the first biasing member 75a.

### Tool Detaching Mechanism

The tool detaching mechanism 85B includes the lever member 86 and the lever mounting shaft 87 having similar configurations to those described in the first embodiment. Since the lever member 86 and the lever mounting shaft 87 have the same configurations as those described in the first embodiment, their illustrations are omitted in FIGS. 9 to 12 for convenience.

The tool detaching mechanism 85B includes a lever abutment part 89B provided at the upper end part of the shaft member 68B. The lever abutment part 89B has an extending wall part 89e extending upward from the upper surface of the shaft end part 72. The extending wall part 89e has an inclined side end surface 89s with which the lever mounting shaft 87 abuts when the lever member 86 is rotated in a lever rotation direction PD. Operation of the tool detaching mechanism 85B when detaching the tool accessory TT will be described after describing operation of a biasing force control mechanism 90B when mounting the tool accessory TT.

### 2-2. Groove of the Cylindrical Member

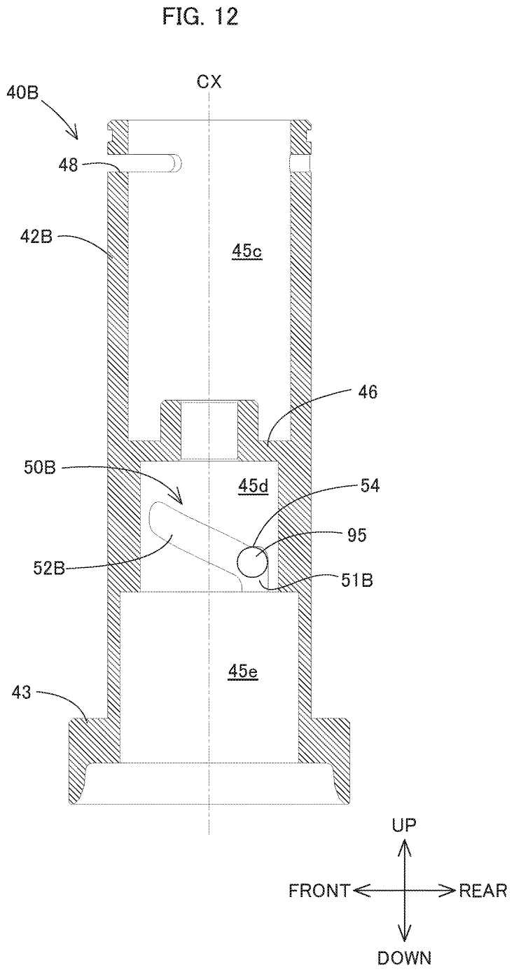

Referring to FIG. 12, as described above, a groove 50B is formed in the inner wall surface of the middle accommodation chamber 45d of the cylindrical member 42B. The groove 50B accommodates the convex part 95 of the rotating member 92 and defines a path along which the convex part 95 can move. The groove 50B has a bottom 53 on which the spherical rolling member configuring the convex part 95 rolls. The groove 50B is configured by a recess having a substantially semicircular cross-sectional shape. FIG. 12 illustrates a position of the convex part 95 in the groove 50B when the opening/closing mechanism 55 is in the closed state.

The groove 50B has a first groove portion 51B extending in the up-down direction, and a second groove portion 52B branching from an upper end part of the first groove portion 51B and extending in an oblique direction between a rotating direction RD and an upward direction. A locking inner wall surface 54, which is an inner wall surface for locking the convex part 95 moving upward, is provided at the upper end part of the first groove portion 51B intersecting with the second groove portion 52B.

As described above, the rotating member 92 having the convex part 95 is in a state of being biased upward by the first biasing member 75a. Therefore, as shown in FIG. 12, when the convex part 95 is located in the first groove portion 51B, the convex part 95 is locked by the locking inner wall surface 54 due to the biasing force, and upward movement thereof is restricted. The first groove portion 51B corresponds to a “restricted region” in which the movement of the convex part 95 in a second direction, which is the upward direction, is restricted.

When the rotating member 92 rotates in the rotating direction RD in a state in which the convex part 95 is locked by the locking inner wall surface 54 of the first groove portion 51B, the convex part 95 moves from the first groove portion 51B to a lower end part of the second groove portion 52B. The convex part 95 is allowed to move in the oblique direction along the second groove portion 52B. The second groove portion 52B corresponds to an “allowed region” in which the movement of the convex part 95 in the oblique direction is allowed. When the convex part 95 moves in the oblique direction, the shaft member 68B moves upward while the rotating member 92 rotates in the rotating direction RD.

### 2-3. Operation of the Biasing Force Control Mechanism

In the mounting mechanism 40B, movement of the moving part 62B for opening and closing the opening/closing mechanism 55 is controlled by the biasing force control mechanism 90B switching a state in which a biasing force of the biasing part 75B acts. The biasing force control mechanism 90B is configured by at least the cylindrical member 42B, the shaft member 68B, and the biasing part 75B. Further, in the second embodiment, the rotating member 92 and the side moving body 96 function as components of the biasing force control mechanism 90B. The biasing force control mechanism 90B is configured to switch the state in which the biasing force of the biasing part 75B acts between when the opening/closing mechanism 55 is in the closed state and when the opening/closing mechanism 55 is opened, by making the aforementioned components cooperate with each other.

First, the state in which the biasing force of the biasing part 75B acts when the opening/closing mechanism 55 is in the closed state will be described with reference to FIGS. 11 and 12. In the state in which the opening/closing mechanism 55 is closed, the biasing force control mechanism 90B makes the biasing force of the biasing part 75B act so as to maintain the closed state of the opening/closing mechanism 55. In the second embodiment, the biasing force control mechanism 90B is configured to bias the side moving body 96 downward by the first biasing member 75a to place the side moving body 96 in the initial position when the opening/closing mechanism 55 is in the closed state.

In addition, the biasing force control mechanism 90B is configured to bias the rotating member 92 upward by the first biasing member 75a so that the convex part 95 is locked by the locking inner wall surface 54 as shown in FIG. 12. In this state, since the shaft member 68B is in a state of being locked by the cylindrical member 42B via the convex part 95 of the rotating member 92, upward movement of the shaft member 68B is restricted. Therefore, an upward biasing force applied to the shaft member 68B by the second biasing member 75b does not act.

As described above, while the side moving body 96 is located in the initial position, the abutment part 97 of the side moving body 96 does not abut against the abutted part 94f of the rotating member 92. Accordingly, rotation of the rotating member 92 in the rotating direction RD is suppressed. While the rotating member 92 does not rotate in the rotating direction RD, the upward movement of the shaft member 68B remains restricted, and the closed state of the opening/closing mechanism 55 is maintained. In this manner, when the opening/closing mechanism 55 is in the closed state, the biasing force of the biasing part 75B acts so as to maintain the closed state of the opening/closing mechanism 55.

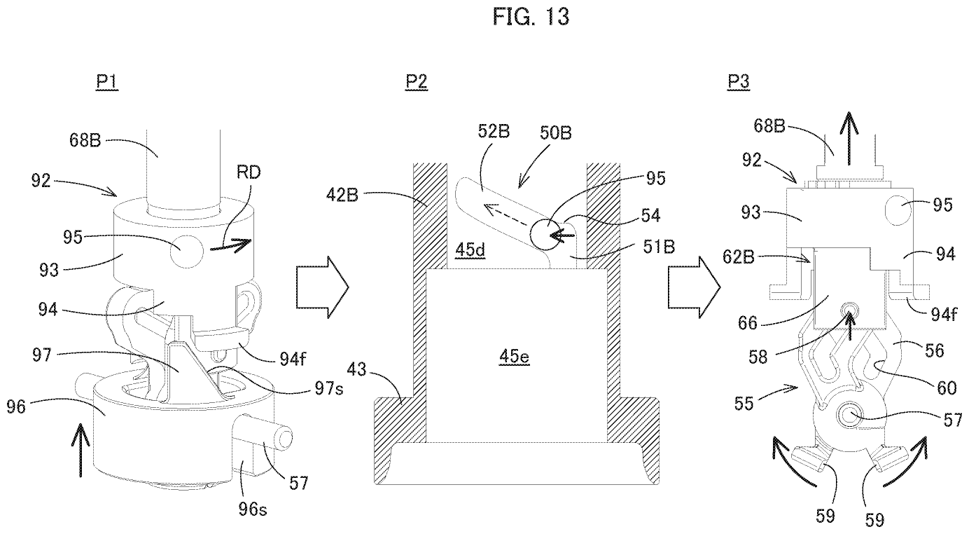

Next, a mechanism in which the opening/closing mechanism 55 is switched from a closed state to an open state by the biasing force control mechanism 90B switching a state in which a biasing force of the biasing part 75B acts will be described, mainly with reference to FIG. 13. FIG. 13 illustrates operations of the biasing force control mechanism 90B in operation processes P1 to P3. As described below, the biasing force control mechanism 90B makes the biasing force act on the shaft member 68B in a direction in which the moving part 62B moves upward to open the opening/closing mechanism 55 by changing a state in which the shaft member 68B is locked relative to the cylindrical member 42B.

The operation process P1 illustrates an operation in which the side moving body 96 is moved upward by a tool accessory TT when the tool accessory TT is mounted to the opening/closing mechanism 55 in the closed state. In the drawing of the operation process P1, illustration of the first biasing member 75a is omitted for convenience. When a peripheral edge part of a mounting hole TH of the tool accessory TT abuts against a lower end part of the side moving body 96 and a prescribed external force exceeding the biasing force applied by the first biasing member 75a is applied to the side moving body 96, the side moving body 96 starts moving upward from the initial position.

When the side moving body 96 moves upward, the abutment part 97 of the side moving body 96 abuts against the abutted part 94f of the rotating member 92 at the inclined end surface 97s. As the side moving body 96 continues to move upward, the abutted part 94f of the rotating member 92 slides on the inclined end surface 97s while being pushed by the inclined end surface 97s, and the rotating member 92 rotates in the rotating direction RD. In this manner, the biasing force control mechanism 90B is configured such that the upward movement of the side moving body 96 is converted into rotation of the rotating member 92 in the rotating direction RD.

The operation process P2 illustrates an operation in which a state where the upward movement of the convex part 95 is restricted is released by rotation of the rotating member 92 in the rotating direction RD. When the rotating member 92 starts rotating in the rotating direction RD, the convex part 95 moves from an upper end part of the first groove portion 51B to a lower end part of the second groove portion 52B. Accordingly, the convex part 95 is switched from a state in which it is restricted from moving upward to a state in which it is allowed to move in an oblique direction along the second groove portion 52B. That is, at this time, the shaft member 68B is in a state in which the upward locking relative to the cylindrical member 42B via the convex part 95 of the rotating member 92 is released.

By releasing the locked state relative to the cylindrical member 42B, the restriction on the upward movement of the shaft member 68B is released. Therefore, the upward biasing force applied to the shaft member 68B by the second biasing member 75b acts, and the shaft member 68B moves upward. The rotating member 92 moves upward together with the shaft member 68B. At this time, since the convex part 95 moves in the oblique direction along the second groove portion 52B, the rotating member 92 moves upward while rotating in the rotating direction RD in accordance with the movement of the convex part 95.

The operation process P3 illustrates an operation in which the moving part 62B moves upward due to the upward movement of the shaft member 68B. As the moving part 62B moves upward, an opening/closing control member 58 of the opening/closing mechanism 55 moves upward, whereby the opening/closing mechanism 55 is opened. In the state in which the opening/closing mechanism 55 is opened, the biasing force applied to the shaft member 68B by the second biasing member 75b acts in a direction to maintain the open state of the opening/closing mechanism 55. Accordingly, the tool accessory TT is fixed to the tool mounting part 43 as shown in FIG. 7 (also referred to in the first embodiment).

### 2-4. Operation of the Tool Detaching Mechanism

When the lever member 86 is rotated in a lever rotation direction PD in a state where the tool accessory TT is fixed to the tool mounting part 43, the lever mounting shaft 87 abuts against the inclined side end surface 89s of the extending wall part 89e of the lever abutment part 89B. As the lever member 86 is rotated in the lever rotation direction PD, the lever mounting shaft 87 rides on the inclined side end surface 89s and slides on the inclined side end surface 89s, and by this movement, the shaft member 68B is pushed downward and moves downward. As the shaft member 68B moves downward, the moving part 62B moves downward, and the opening/closing mechanism 55 is closed. Further, the convex part 95 of the rotating member 92 moves obliquely downward along the second groove portion 52B, and accordingly, the rotating member 92 rotates in a direction opposite to that in the mounting process of the tool accessory TT. When the convex part 95 returns to the position at the upper end part of the first groove portion 51B shown in FIG. 12 and the upward movement of the shaft member 68B becomes restricted, the opening/closing mechanism 55 is in the closed state, and the tool accessory TT can be detached.

### 2-5. Summary of the Second Embodiment

As described above, according to the power tool of the second embodiment, the closed state of the opening/closing mechanism 55 can be maintained by the biasing force applied by the biasing force control mechanism 90B. Further, when a prescribed external force is applied from the tool accessory TT in the state in which the opening/closing mechanism 55 is closed, the biasing force control mechanism 90B switches the state in which the biasing force acts, whereby the opening/closing mechanism 55 is opened and the tool accessory TT can be fixed. According to the configuration of the second embodiment, the tool accessory TT can be mounted to the power tool 10 by a simple one-touch operation of only applying an external force via the tool accessory TT.

According to the configuration of the second embodiment, switching of the state in which the biasing force acts can be easily realized by a mechanism capable of restricting the movement of the shaft member 68B by locking it relative to the cylindrical member 42B. Further, according to the configuration of the second embodiment, a configuration for controlling the restriction of the movement of the shaft member 68B can be easily realized by a configuration for controlling the movement of the convex part 95 of the rotating member 92 by the groove 50B.

According to the configuration of the second embodiment, since the convex part 95 is configured by a rolling member that rolls on the bottom surface of the groove 50B, the movement of the convex part 95 can be smoothed. Further, since the groove 50B of the cylindrical member 42B has the bottom surface and does not penetrate through a side wall part of the cylindrical member 42B, entry of foreign matter into the inside of the cylindrical member 42B through the groove 50B can be suppressed. Accordingly, it is possible to suppress occurrence of a problem such as the movement of the shaft member 68B being inhibited due to the entry of foreign matter into the inside of the cylindrical member 42B.

According to the configuration of the second embodiment, the rotating member 92 can be rotated by the side moving body 96, and the movement of the convex part 95 within the groove 50B accompanying the rotation of the rotating member 92 can be controlled. Therefore, a configuration in which the movement of the shaft member 68B is controlled by controlling the movement of the convex part 95 can be realized by a simple configuration of making the rotating member 92 and the side moving body 96 cooperate with each other.

### 3. Third Embodiment

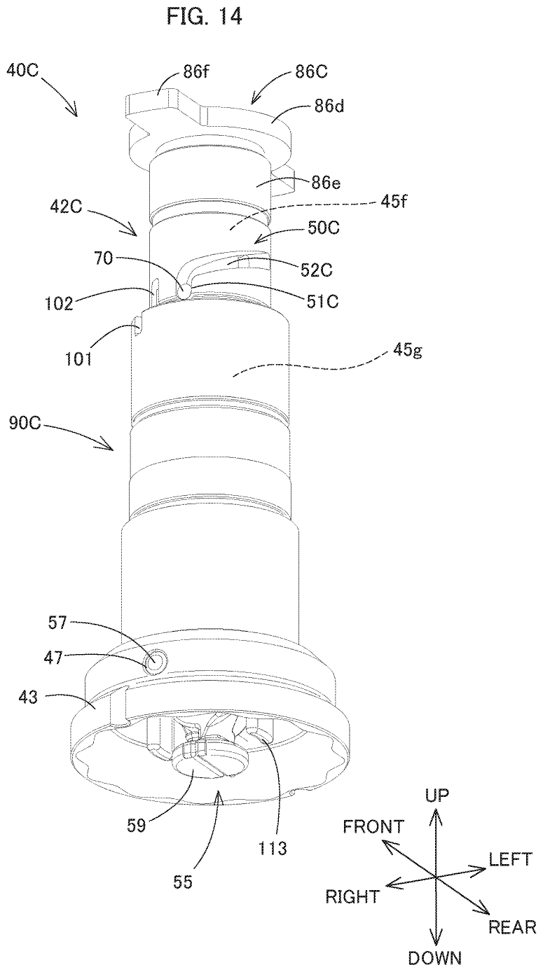

A configuration of a mounting mechanism 40C provided in a power tool of a third embodiment will be described with reference to FIGS. 14 to 19. The configuration of the power tool of the third embodiment is substantially the same as that of the power tool 10 of the first embodiment, except for the configuration of the mounting mechanism 40C. The configuration of the mounting mechanism 40C of the third embodiment is basically the same as the configuration of the mounting mechanism 40A of the first embodiment or the mounting mechanism 40B of the second embodiment, unless otherwise described below.

### 3-1. Components of the Mounting Mechanism

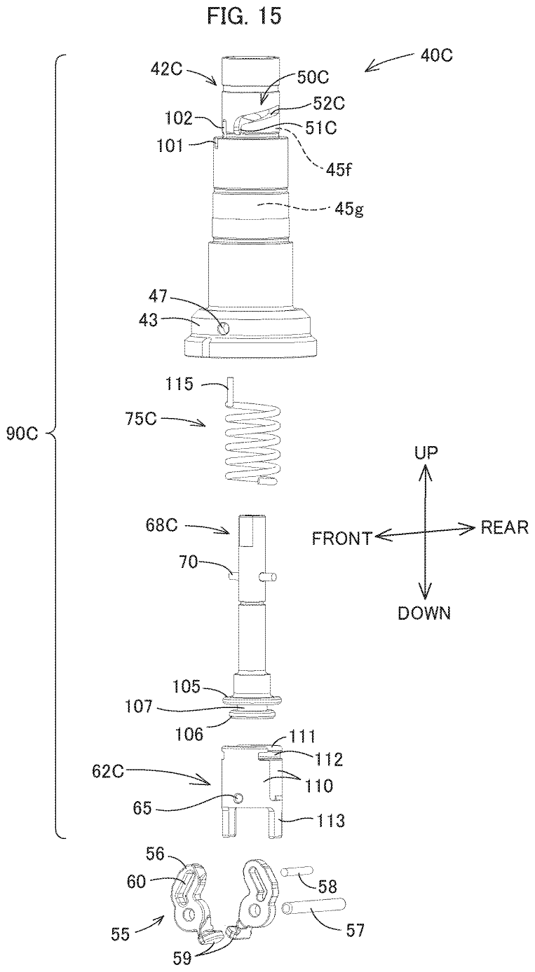

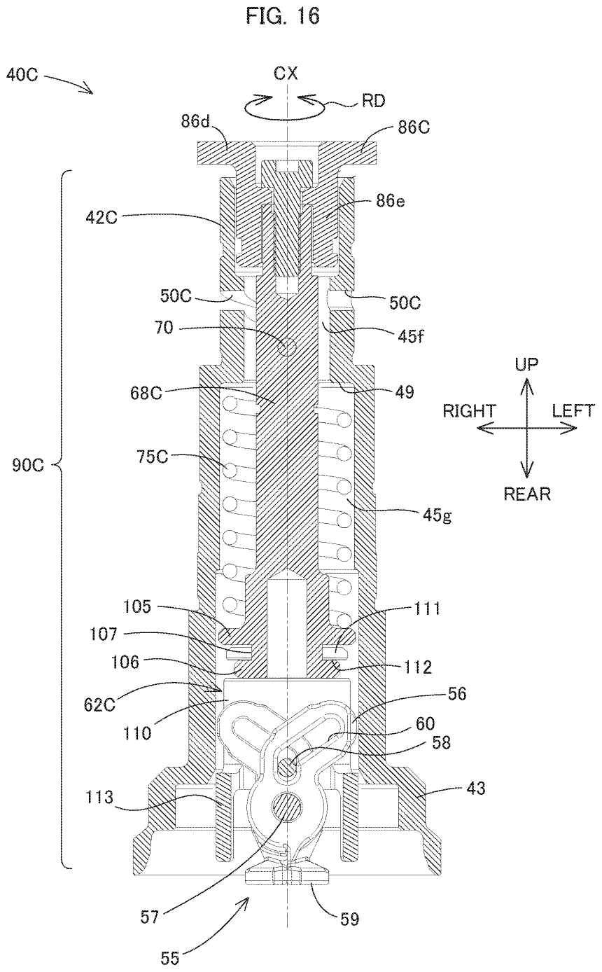

Components of the mounting mechanism 40C of the third embodiment will be described with reference to FIGS. 14 to 18, as appropriate. In FIGS. 14 and 16, the opening/closing mechanism 55 is illustrated in the closed state. In FIG. 15, illustration of the lever member 86C shown in FIGS. 14 and 16 is omitted for convenience. The mounting mechanism 40C includes the opening/closing mechanism 55, a cylindrical member 42C, a shaft member 68C, the lever member 86C, a moving part 62C, and a biasing part 75C. Since the configuration of the opening/closing mechanism 55 is substantially the same as that of the first embodiment, detailed description thereof is omitted.

### Cylindrical Member

Similarly to the cylindrical member 42A of the first embodiment, a cylindrical member 42C of the third embodiment is a cylindrical metal member and configures a housing of the mounting mechanism 40C. The cylindrical member 42C surrounds an outer periphery of the shaft member 68C and accommodates the moving part 62C and the biasing part 75C.

A tool mounting part 43 is provided at a lower end part of the mounting mechanism 40C. An opening/closing mechanism 55 is held in the tool mounting part 43 with a configuration similar to that described in the second embodiment. As shown in FIGS. 14 and 16, in a state where the opening/closing mechanism 55 is closed, a downwardly extending part 113 of the moving part 62C, which will be described later, protrudes into the tool mounting part 43.

As shown in FIG. 16, an internal space of the cylindrical member 42C above the tool mounting part 43 is partitioned into two spaces arranged in the up-down direction. The internal space of the cylindrical member 42C is partitioned into an upper-end side accommodation chamber 45f and a lower-end side accommodation chamber 45g. An inner diameter of the upper-end side accommodation chamber 45f is smaller than an inner diameter of the lower-end side accommodation chamber 45g. Accordingly, a stepped surface 49 facing downward is formed at an upper end of the lower-end side accommodation chamber 45g.

An upper-end side part of the shaft member 68C is accommodated in the upper-end side accommodation chamber 45f. A cylindrical part of a lever member 86C, which will be described later and is connected to an upper end of the shaft member 68C, is fitted into an opening at an upper end part of the upper-end side accommodation chamber 45f.

As shown in FIGS. 14 and 15, a groove 50C is formed in a side wall part of the upper-end side accommodation chamber 45f. As shown in FIG. 16, the groove 50C penetrates through the side wall part of the upper-end side accommodation chamber 45f. The grooves 50C are formed at two positions facing each other in a radial direction across a center axis CX.

As shown in FIG. 15, the groove 50C extends obliquely upward from a lower end part of the upper-end side accommodation chamber 45f. The groove 50C has, at a lower end part thereof, a first groove part 51C extending upward along a direction of the center axis CX, and a second groove part 52C branching from an upper end part of the first groove part 51C and extending in an oblique direction between an upward direction and a rotating direction RD. A protruding part 70, which will be described later and is provided at the upper-end side part of the shaft member 68C, is inserted into the groove 50C. A function of the groove 50C will be described later.

A lower-end side part of the shaft member 68C, the biasing part 75C, the moving part 62C connected to a lower end part of the shaft member 68C, and a part of the opening/closing mechanism 55 above a pivot shaft member 57 are accommodated in the lower-end side accommodation chamber 45g.

As shown in FIGS. 14 and 15, an upper-end through-hole 101 penetrating through a wall part is formed in the wall part of the upper end part of the lower-end side accommodation chamber 45g. Further, a lower-end groove part 102 communicating with the upper-end through-hole 101 and extending in the up-down direction is formed on an outer side of a wall part of the lower end part of the upper-end side accommodation chamber 45f. As will be described later, an upper-end engagement part 115 of the biasing part 75C is arranged in the upper-end through-hole 101 and the lower-end groove part 102.

### Shaft Member

The shaft member 68C is arranged in the cylindrical member 42C so as to be rotatable in a rotating direction RD around a center axis CX relative to the cylindrical member 42C. A protruding part 70 is provided at an upper-end side part of the shaft member 68C. The protruding part 70 is configured by a shaft-like member mounted so as to penetrate through the shaft member 68C in a direction orthogonal to the center axis CX. The protruding part 70 protrudes on both sides in a radial direction of the shaft member 68C. As described above, the protruding part 70 is inserted into the groove 50C of the cylindrical member 42C. A function of the protruding part 70 will be described later together with a function of the groove 50C.

A pair of flanges 105 and 106 formed adjacent to each other in the up-down direction are formed at a lower end part of the shaft member 68C. Each of the pair of flanges 105 and 106 is a rib-like part configured by an end wall part that protrudes in the radial direction of the shaft member 68C and extends annularly in a circumferential direction of the shaft member 68C.

The upper flange 105 functions as a support part that supports a lower end of the biasing part 75C. The lower flange 106 is a part to be fitted into a fitting groove 112 (to be described later) of the moving part 62C. In addition, an annular groove part 107 formed between the pair of flanges 105 and 106 is a part into which a fitting part 111 provided at an upper end of the moving part 62C is fitted.

### Lever Member

The lever member 86C is provided at the upper end part of the shaft member 68C. The lever member 86C has a disc-shaped main body part 86d having a circular shape centered on the center axis CX, a downward cylindrical part 86e extending downward from a lower surface of the disc-shaped main body part 86d, and a pair of plate parts 86f extending to both sides in the radial direction from an outer peripheral end of the disc-shaped main body part 86d.

A diameter of the disc-shaped main body part 86d is larger than a diameter of the upper end part of the cylindrical member 42C, and the disc-shaped main body part 86d is arranged so as to cover an opening at the upper end part of the cylindrical member 42C. The downward cylindrical part 86e is fitted into the opening at the upper end part of the cylindrical member 42C. The pair of plate parts 86f functions as a finger-hooking part for a user of the power tool.

In the mounting mechanism 40C, by rotating the lever member 86C around the center axis, the opening/closing mechanism 55 in the open state is brought into the closed state, so that the tool accessory TT fixed to the tool mounting part 43 can be detached. An operation of the biasing force control mechanism 90C when the lever member 86C is rotated will be described later.

### Moving Part

The moving part 62C is connected to the lower end part of the shaft member 68C in a state where rotation around the center axis CX relative to the shaft member 68C is allowed. The moving part 62C moves in the up-down direction within the cylindrical member 42C together with the shaft member 68C. As shown in FIG. 15, the moving part 62C has a pair of curved side wall parts 110 and a pair of downward extending parts 113.

Each of the pair of curved side wall parts 110 has a shape curved along an outer peripheral side surface of the shaft member 68C. A fitting part 111 is provided at an upper end part of each of the pair of curved side wall parts 110, and is fitted into the annular groove part 107 between the pair of flanges 105 and 106 provided at the lower end of the shaft member 68C. In addition, a fitting groove 112 into which the lower flange 106 of the shaft member 68C is fitted is provided at the upper end part of each of the pair of curved side wall parts 110.

Support holes 65 into which both end parts of the opening/closing control member 58 of the opening/closing mechanism 55 are inserted are provided at lower end parts of the pair of curved side wall parts 110. The moving part 62C is connected to the opening/closing mechanism 55 by the opening/closing control member 58 being supported in the support holes 65. By this connection, the moving part 62C can operate the opening/closing mechanism 55 in a direction to open when moving upward, and can operate the opening/closing mechanism 55 in a direction to close when moving downward.

The pair of downward extending parts 113 extends in the up-down direction at a side of the opening/closing mechanism 55. An upper end part of each of the pair of downward extending parts 113 connects the lower end parts of the pair of curved side wall parts 110 to each other. The pair of downward extending parts 113 is arranged so as to sandwich a part of the opening/closing mechanism 55 including the opening/closing control member 58 in the left-right direction.

As described above, lower end parts of the pair of downward extending parts 113 are arranged in the tool mounting part 43. When the tool accessory TT is mounted to the opening/closing mechanism 55 in the closed state, a peripheral edge part of the mounting hole TH of the tool accessory TT abuts against the lower end parts of the pair of downward extending parts 113 and applies an upward external force thereto.

### Biasing Part

Referring to FIG. 16, a biasing part 75C is configured by a coil-shaped spring and is arranged around an outer periphery of the shaft member 68C inside the cylindrical member 42C. The biasing part 75C is arranged in a state where an upper end thereof abuts against a stepped surface 49 configuring an upper wall surface of the lower-end side accommodation chamber 45g and a lower end thereof abuts against an upper surface of the upper flange 105 of the shaft member 68C.

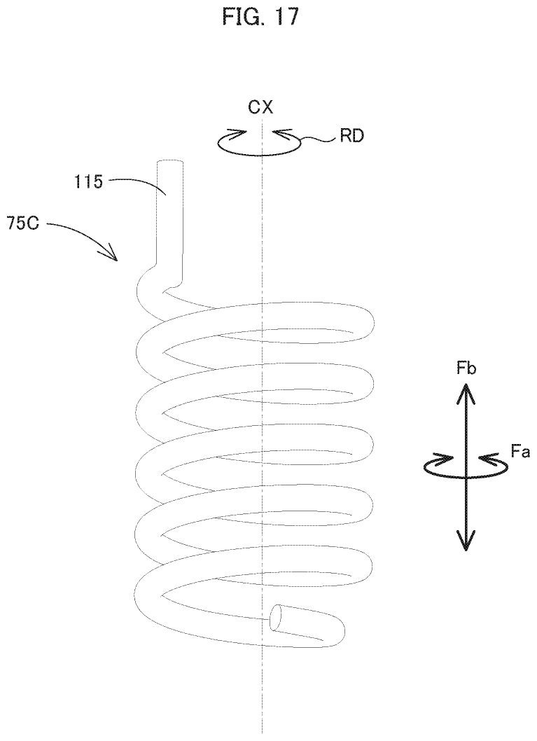

Referring to FIG. 17, the biasing part 75C is illustrated in a posture when accommodated in the cylindrical member 42C. In FIG. 17, a center axis CX of the cylindrical member 42C is illustrated. The biasing part 75C is arranged in the cylindrical member 42C in a state where a center axis thereof substantially coincides with the center axis CX.

The biasing part 75C is configured by a torsion spring. The biasing part 75C generates a biasing force Fa acting in a direction around the center axis by torsional deformation in a winding direction, and also generates a biasing force Fb acting in a direction along the center axis by expansion and contraction deformation.

The biasing part 75C is provided with a columnar upper-end engagement part 115 at an upper end part thereof, the upper-end engagement part 115 extending upward along the direction of the center axis CX. When the biasing part 75C is installed in the upper-end side accommodation chamber 45f, the upper-end engagement part 115 is inserted into the upper-end through-hole 101 shown in FIG. 15 and is arranged in the lower-end groove part 102 on an outer side. Accordingly, the biasing part 75C is connected to the cylindrical member 42C in a state where rotation in the direction around the center axis CX is restricted.

With this configuration, by inserting the biasing part 75C into the lower-end side accommodation chamber 45g from below and inserting the upper-end engagement part 115 of the biasing part 75C into the upper-end through-hole 101, the upper-end engagement part 115 can reach the lower-end groove part 102. Therefore, assembling of the biasing part 75C to the cylindrical member 42C is facilitated.

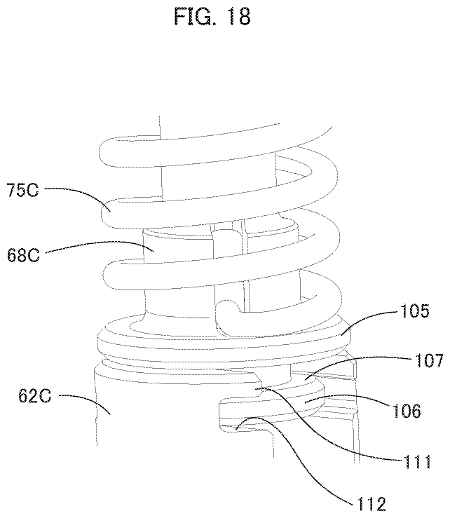

As shown in FIG. 18, the biasing part 75C is connected to the shaft member 68C by inserting a lower end part of the biasing part 75C from a side surface of the shaft member 68C into an inside thereof. Accordingly, the biasing part 75C is connected also to the shaft member 68C in a state where rotation in the direction around the center axis CX is restricted.

Referring to FIG. 16, the biasing part 75C is arranged in a compressed state in the lower-end side accommodation chamber 45g. In a state where the biasing part 75C is released from the compressed state, the biasing part 75C generates the biasing force Fb in an extension direction along the center axis CX while generating the biasing force Fa acting in the rotating direction RD.

The biasing part 75C applies the biasing force Fa in the rotating direction RD to the shaft member 68C by the lower end part inserted into the side wall surface of the shaft member 68C in the lower-end side accommodation chamber 45g. In addition, the biasing part 75C applies the downward biasing force Fb to the shaft member 68C via the upper flange 105 at the lower end part of the shaft member 68C.

### 3-2. Operation of the Biasing Force Control Mechanism

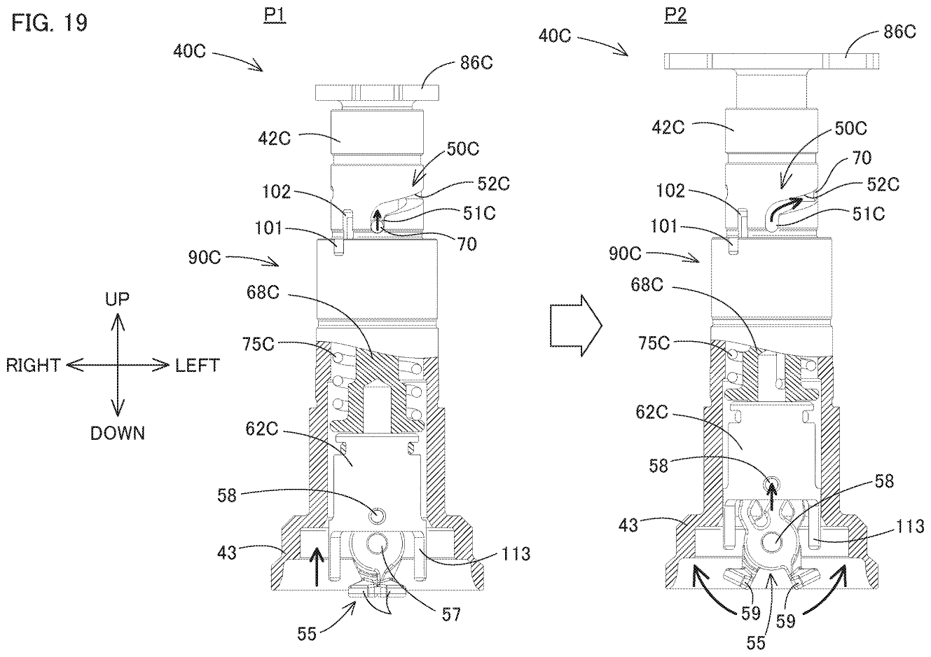

Operation of the biasing force control mechanism 90C when the opening/closing mechanism 55 in the closed state is brought into the open state will be described with reference to FIG. 19. The operation process P1 in FIG. 19 illustrates a state of the mounting mechanism 40C when the opening/closing mechanism 55 is in the closed state. The operation process P2 illustrates an operation of the mounting mechanism 40C when the opening/closing mechanism 55 is opened. In FIG. 19, an upper-end side of the cylindrical member 42C is shown in an external view, and a lower-end side of the cylindrical member 42C is shown in a sectional view.

In the mounting mechanism 40C, movement of the moving part 62C for opening and closing the opening/closing mechanism 55 is controlled by the biasing force control mechanism 90C switching a state in which a biasing force of the biasing part 75C acts. The biasing force control mechanism 90C is configured by at least the cylindrical member 42C, the shaft member 68C, and the biasing part 75C. The biasing force control mechanism 90C is configured to switch the state in which the biasing force of the biasing part 75C acts between when the opening/closing mechanism 55 is in the closed state and when the opening/closing mechanism 55 is opened, by making the aforementioned components cooperate with each other.

First, the state of the mounting mechanism 40C when the opening/closing mechanism 55 is in the closed state will be described with reference to the drawing of the operation process P1 in FIG. 19.

The biasing force control mechanism 90C is configured such that the protruding part 70 of the shaft member 68C is located in the first groove part 51C of the groove 50C when the opening/closing mechanism 55 is in the closed state. Accordingly, the protruding part 70 is in a state of being sandwiched between inner wall surfaces of the groove 50C in the rotating direction RD, and the shaft member 68C is in a state of being locked relative to the cylindrical member 42C in the rotating direction RD. The first groove part 51C of the groove 50C corresponds to a “restricted region” in which movement of the protruding part 70 in the rotating direction RD is restricted. In this state, the biasing force Fa of the biasing part 75C in the rotating direction does not act on the shaft member 68C.

Meanwhile, the shaft member 68C is in a state in which a biasing force in a first direction is applied thereto by the biasing part 75C. By the action of this biasing force, the moving part 62C connected to the shaft member 68C and the opening/closing control member 58 supported by the moving part 62C are biased downward, and the closed state of the opening/closing mechanism 55 is maintained.

Next, operation of the mounting mechanism 40C from when the opening/closing mechanism 55 is in the closed state to when the opening/closing mechanism 55 is opened will be described with reference to the drawings of the operation processes P1 and P2 in FIG. 19. As will be described below, the biasing force control mechanism 90C opens the opening/closing mechanism 55 by changing a state in which the shaft member 68C is locked relative to the cylindrical member 42C, so as to apply a biasing force to the shaft member 68C in a direction in which the moving part 62C moves upward.

When the tool accessory TT is mounted to the opening/closing mechanism 55 in the closed state shown in the operation process P1, a peripheral edge part of the mounting hole TH of the tool accessory TT abuts against the downward extending parts 113 of the moving part 62C extending into the tool mounting part 43. When a predetermined external force exceeding the downward biasing force Fb applied to the shaft member 68C by the biasing part 75C is applied from the tool accessory TT to the downward extending parts 113, the moving part 62C starts moving upward. Then, the shaft member 68C connected to the moving part 62C moves upward, and the protruding part 70 of the shaft member 68C moves upward along the first groove part 51C of the groove 50C.

When the protruding part 70 reaches an upper end of the first groove part 51C, as shown in the operation process P2, the protruding part 70 is allowed to move to the second groove part 52C extending in an oblique direction. The second groove part 52C corresponds to an “allowed region” in which movement of the protruding part 70 in the rotating direction RD is allowed.

In this state, the shaft member 68C is released from being locked relative to the cylindrical member 42C in the rotating direction RD, and rotation in the rotating direction RD is allowed. Therefore, the biasing force Fa in the rotating direction RD applied from the biasing part 75C to the shaft member 68C acts, and the shaft member 68C starts rotating in the rotating direction RD relative to the cylindrical member 42C.

Then, since the protruding part 70 moves obliquely upward along the second groove part 52C, the shaft member 68C moves upward. When the shaft member 68C moves upward, the moving part 62C moves upward, and the opening/closing mechanism 55 is brought into the open state. Thereafter, the biasing force of the biasing part 75C in the rotating direction RD acts in a direction to maintain the open state of the opening/closing mechanism 55.

### 3-3. Process of Detaching the Tool Accessory

In order to detach the tool accessory TT fixed to the tool mounting part 43, the lever member 86C at the upper end part of the shaft member 68C is rotated so as to rotate in a direction opposite to a direction in which the shaft member 68C rotates when opening the opening/closing mechanism 55. Accordingly, the shaft member 68C rotates, and the protruding part 70 moves obliquely downward along the second groove part 52C. The shaft member 68C moves downward while rotating, and the opening/closing mechanism 55 is closed. When the opening/closing mechanism 55 is brought into a completely closed state, the protruding part 70 is located at the lower end part of the first groove part 51C, and the shaft member 68C returns to a state of being locked relative to the cylindrical member 42C in the rotating direction RD.

### 3-4. Summary of the Third Embodiment

As described above, according to the power tool of the third embodiment, the closed state of the opening/closing mechanism 55 can be maintained by the biasing force applied by the biasing force control mechanism 90C. Further, when a prescribed external force is applied from the tool accessory TT in a state where the opening/closing mechanism 55 is closed, the biasing force control mechanism 90C changes the locked state of the shaft member 68C relative to the cylindrical member 42C to switch the state in which the biasing force acts. Accordingly, the opening/closing mechanism 55 can be operated in a direction to open, and the tool accessory TT can be fixed. According to the configuration of the third embodiment, the tool accessory TT can be mounted to the power tool 10 by a simple one-touch operation of only applying an external force via the tool accessory TT.

According to the configuration of the third embodiment, switching of the state in which the biasing force acts on the shaft member 68C can be easily realized by a configuration that changes the locked state of the shaft member 68C relative to the cylindrical member 42C in the rotating direction RD. Further, according to the configuration of the third embodiment, the biasing force in the rotating direction RD and the biasing force in the up-down direction can be generated by a single torsion spring configuring the biasing part 75C. Therefore, the number of components of the biasing force control mechanism 90C can be reduced, and a size thereof can be reduced. According to the configuration of the third embodiment, by a configuration in which the protruding part 70 of the shaft member 68C and the groove 50C of the cylindrical member 42C cooperate with each other, control of the locked state of the shaft member 68C relative to the cylindrical member 42C can be realized by a simple configuration.

### 4. Fourth Embodiment

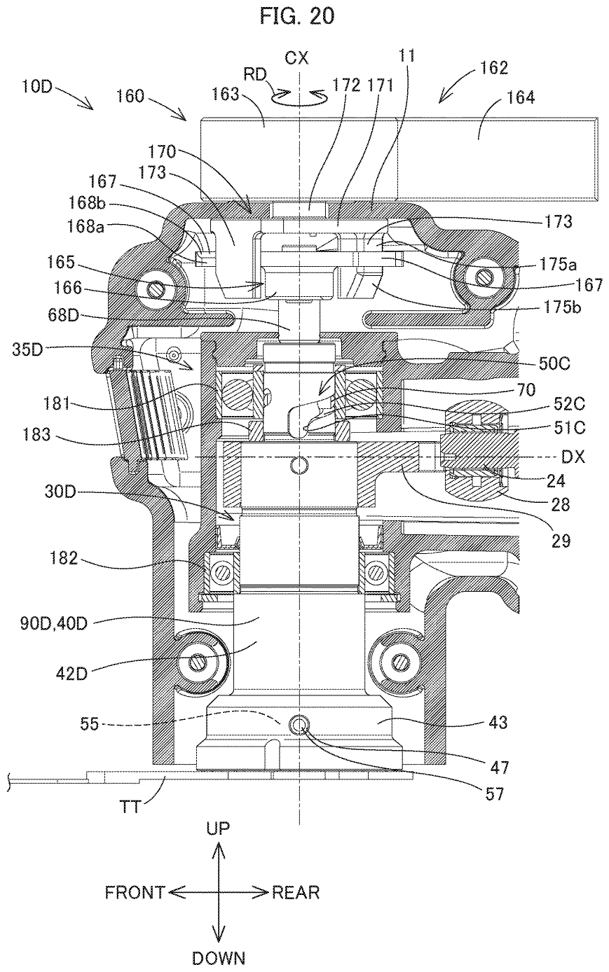

A configuration of a mounting mechanism 40D provided in a power tool 10D of a fourth embodiment will be described with reference to FIG. 20 to FIG. 23 as appropriate.

Referring to FIG. 20, a state in which a tool accessory TT is fixed to the mounting mechanism 40D is illustrated. In FIG. 20, the mounting mechanism 40D and the tool accessory TT are not illustrated in a sectional view.

A configuration of the power tool 10D of the fourth embodiment is substantially the same as that of the power tool 10 of the first embodiment except for the following points. The power tool 10D is provided with the mounting mechanism 40D of the fourth embodiment having a different configuration, instead of the mounting mechanism 40A described in the first embodiment. The configuration of the mounting mechanism 40D of the fourth embodiment is basically substantially the same as the configuration of the mounting mechanism 40C of the third embodiment, except for points not described as differences below. A biasing force control mechanism 90D of the mounting mechanism 40D of the fourth embodiment is configured similarly to the biasing force control mechanism 90C of the third embodiment.

A lever operation part 162 of a detaching operation part 160 for detaching the tool accessory TT, which is provided in the mounting mechanism 40D, is provided on an upper surface of a tip end part of the power tool 10D. The power tool 10D is provided with a spindle holding mechanism 35D that holds a spindle 30D including the mounting mechanism 40D. A configuration of the spindle holding mechanism 35D is different from that of the spindle holding mechanism 35.

In the following description and the reference drawings, components denoted by the same reference numerals as those used in the above respective embodiments have configurations and functions similar to those described in the above respective embodiments, unless otherwise specified.

### 4-1. Structure of the Mounting Mechanism

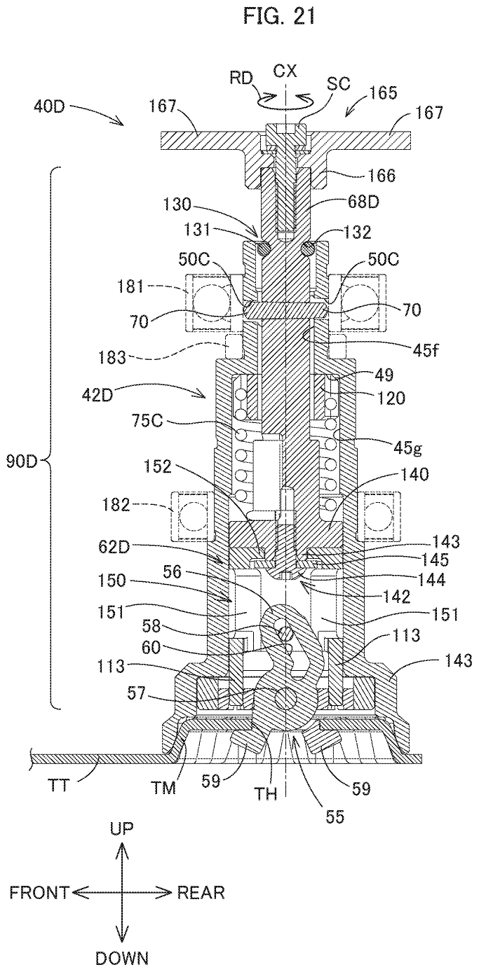

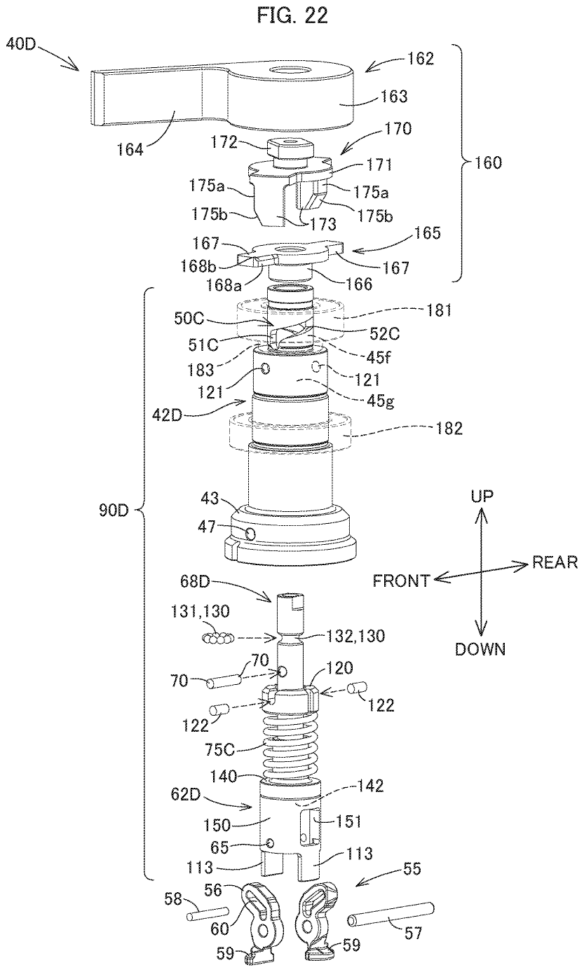

Referring to FIG. 21 and FIG. 22, a mounting mechanism 40D of the fourth embodiment includes an opening/closing mechanism 55, a cylindrical member 42D, a shaft member 68D, a biasing part 75C, a moving part 62D, a shaft support part 130, a biasing part support member 120, and a detaching operation part 160. These components will be described below in this order. However, since a configuration of the opening/closing mechanism 55 is substantially the same as that of the first embodiment, detailed description thereof will be omitted.

### Cylindrical Member

As shown in FIG. 21 and FIG. 22, similarly to the cylindrical member 42C of the third embodiment, the cylindrical member 42D has an upper-end side accommodation chamber 45f and a lower-end side accommodation chamber 45g. Further, as shown in FIG. 20 and FIG. 22, the cylindrical member 42D has a groove 50C in a side wall part of the upper-end side accommodation chamber 45f, similarly to that described in the third embodiment.

A protruding part 70 provided on the shaft member 68D is inserted into the groove 50C. The groove 50C configures a moving path of the protruding part 70 as described in the third embodiment, and has a first groove part 51C corresponding to a “restricted region” and a second groove part 52C corresponding to an “allowed region.”

As described in the third embodiment, the groove 50C is formed as a through-groove penetrating the side wall part of the upper-end side accommodation chamber 45f. Accordingly, the protruding part 70 can be deeply inserted, so that the protruding part 70 can be suppressed from coming off from the groove 50C. In addition, the groove 50C configured by the through-groove can be easily formed in the side wall part of the cylindrical member 42D.

The groove 50C is provided in the side wall part of the upper-end side accommodation chamber 45f having a small inner diameter. Accordingly, a distance between a side surface of the shaft member 68D and the groove 50C can be shortened. Therefore, a height of the protruding part 70 protruding from the side surface of the shaft member 68D can be shortened, so that strength of the protruding part 70 is easily increased, and occurrence of damage or deterioration such as bending of the protruding part 70 can be suppressed.

In the cylindrical member 42D, the upper-end through-hole 101 and the lower-end groove part 102, which were provided in the cylindrical member 42C of the third embodiment for fixing the biasing part 75C shown in FIG. 14, are omitted. Instead, a biasing part support member 120, which will be described later, is accommodated in the cylindrical member 42D.

As shown in FIG. 22, a pair of side-wall shaft holes 121 is provided as through-holes in a side wall part of the lower-end side accommodation chamber 45g of the cylindrical member 42D. The pair of side-wall shaft holes 121 is provided at positions facing each other across the center axis CX. As will be described later, a pair of holding shafts 122 for fixing the biasing part support member 120 is inserted into the pair of side-wall shaft holes 121, respectively.

### Shaft Member

As shown in FIG. 21, a shaft member 68D is arranged within the cylindrical member 42D such that a center axis thereof coincides with the center axis CX of the cylindrical member 42D. The shaft member 68D is arranged so as to extend over the upper-end side accommodation chamber 45f and the lower-end side accommodation chamber 45g. The shaft member 68D is accommodated in the cylindrical member 42D in a state where an upper end part thereof extends from an opening at the upper end of the cylindrical member 42D. A lever connection part 165 of the detaching operation part 160 is mounted to the upper end part of the shaft member 68D. The detaching operation part 160 and the lever connection part 165 will be described later.

An annular shaft recessed part 132 centered on the center axis CX is formed in a side surface of a part of the shaft member 68D accommodated in the upper-end side accommodation chamber 45f of the cylindrical member 42D. An inner wall surface of the shaft recessed part 132 is configured by a semicircular curved surface. The shaft recessed part 132 configures a shaft support part 130, which will be described later.

The protruding part 70, which was also described in the third embodiment, is provided at a part of the shaft member 68D below the shaft recessed part 132. The protruding part 70 is provided at a part of the shaft member 68D accommodated in the upper-end side accommodation chamber 45f. The protruding part 70 protrudes to both sides in the radial direction of the shaft member 68D.

As shown in FIG. 21 and FIG. 22, the protruding part 70 is formed by a shaft-like member penetrating the shaft member 68D in a direction orthogonal to the center axis CX. As described above, the protruding part 70 is inserted into the groove 50C of the cylindrical member 42D.

A lower-end flange part 140 protruding in the radial direction of the shaft member 68D is formed at a lower end part of the shaft member 68D. A diameter of the lower-end flange part 140 is substantially the same as the inner diameter of the cylindrical member 42D. The lower-end flange part 140 functions as a support part that supports a lower end of the biasing part 75C. A lower-end connection part 142 for connecting the moving part 62D is provided at a center part of a lower surface side of the lower-end flange part 140 of the shaft member 68D.

As shown in FIG. 21, the lower-end connection part 142 includes a cylindrical screw mounting part 143, a fastening screw 144, and an annular member 145. The screw mounting part 143 extends along the center axis CX from a center of the lower surface of the lower-end flange part 140. The fastening screw 144 is inserted into the screw mounting part 143 from below and is fastened. The annular member 145 is fixed to a lower end of the screw mounting part 143 by an inner peripheral edge part thereof being sandwiched between a lower end surface of the screw mounting part 143 and a head of the fastening screw 144. Connection of the moving part 62D to the shaft member 68D by the lower-end connection part 142 will be described in the section of the “moving part 62D.”

### Biasing Part

The biasing part 75C has a configuration similar to that described in the third embodiment, and as described with reference to FIG. 17, generates a biasing force Fa in a direction around the center axis CX and a biasing force Fb acting in a direction along the center axis CX. The biasing part 75C is configured by, for example, a torsion spring. The biasing part 75C is accommodated in the lower-end side accommodation chamber 45g of the cylindrical member 42D and is arranged on an outer periphery of the shaft member 68D.

In the fourth embodiment, an upper end part of the biasing part 75C is fixed to a biasing part support member 120, which will be described later, and is supported in a state where movement in the direction around the center axis CX is restricted. A lower end part of the biasing part 75C is connected to the shaft member 68D by being inserted into an inside of the shaft member 68D from a side surface of the shaft member 68D on an upper surface of the lower-end flange part 140 of the shaft member 68D.

### Moving Part

As shown in FIG. 21 and FIG. 22, the moving part 62D has a cylindrical body part 150. An upper end side and a lower end side of the cylindrical body part 150 are respectively open. The cylindrical body part 150 is connected to the lower-end connection part 142 at the lower end of the shaft member 68D in a state where a center axis thereof coincides with the center axis of the shaft member 68D. A diameter of the cylindrical body part 150 is substantially the same as a diameter of the lower-end flange part 140 of the shaft member 68D.

As shown in FIG. 22, a pair of downward extending parts 113 is provided at a lower end part of the cylindrical body part 150. The pair of downward extending parts 113 has a configuration and a function similar to those of the moving part 62C of the third embodiment.

Further, at the lower end part of the cylindrical body part 150, support holes 65 are provided, into which both end parts of the opening/closing control member 58 of the opening/closing mechanism 55 are inserted, similarly to the moving part 62C of the third embodiment. Furthermore, a side opening part 151 is formed in a side wall part of the cylindrical body part 150 so as to avoid interference with the opening/closing mechanism 55 that performs an opening/closing operation.

As shown in FIG. 21, an annular inner peripheral edge wall part 152 protruding toward the center axis CX is provided at an upper end part of the cylindrical body part 150. The screw mounting part 143 of the lower-end connection part 142 provided at the lower end of the shaft member 68D is inserted into a central opening of the inner peripheral edge wall part 152.

The moving part 62D is connected to the lower end part of the shaft member 68D by the inner peripheral edge wall part 152 at the upper end part being sandwiched and held between the lower-end flange part 140 of the shaft member 68D and the annular member 145 of the lower-end connection part 142. A thickness of a part of the inner peripheral edge wall part 152 sandwiched between the lower-end flange part 140 and the annular member 145 is smaller than a height of the screw mounting part 143 protruding from a lower surface of the lower-end flange part 140. Accordingly, the moving part 62D is connected to the shaft member 68D in a state where rotation around the center axis CX relative to the shaft member 68D is allowed.

### Shaft Support Part

Referring to FIG. 21 and FIG. 22, a shaft support part 130 is provided on an outer periphery of the shaft member 68D in the cylindrical member 42D. The shaft support part 130 is provided in the upper-end side accommodation chamber 45f of the cylindrical member 42D. The shaft support part 130 guides rotation of the shaft member 68D in the rotating direction RD around the center axis CX and movement thereof in the first direction and the second direction along the center axis CX within the cylindrical member 42D.

The shaft support part 130 includes a plurality of rolling bodies 131 arranged on the outer periphery of the shaft member 68D. Each of the rolling bodies 131 is configured by a spherical body such as a steel ball. The rolling bodies 131 are arranged in an annular shape as shown in FIG. 22 so as to be rollable within the shaft recessed part 132 of the shaft member 68D.

The shaft member 68D is maintained in an appropriate arrangement posture in which the shaft member 68D is suppressed from being displaced from the center axis CX of the cylindrical member 42D by support of the shaft support part 130. Further, the shaft member 68D can smoothly perform the above-described rotation and movement in a state where occurrence of friction is suppressed by rolling of the rolling bodies 131 of the shaft support part 130.

In this way, since the mounting mechanism 40D includes the shaft support part 130, movement of the shaft member 68D within the cylindrical member 42D accompanying opening and closing of the opening/closing mechanism 55 can be performed in a stable state with low friction. Accordingly, attachment and detachment of the tool accessory TT to and from the opening/closing mechanism 55 are further facilitated.

In the fourth embodiment, as described above, the shaft support part 130 is realized by a simple configuration in which the rolling bodies 131 are arranged between an inner wall surface of the cylindrical member 42D and the shaft recessed part 132 of the shaft member 68D. Accordingly, an increase in size and weight of the mounting mechanism 40D due to provision of the shaft support part 130 is suppressed.

In the fourth embodiment, the shaft support part 130 is provided at an upper end part of the cylindrical member 42D. Accordingly, tilting of the shaft member 68D relative to the center axis CX can be more effectively suppressed.

### Biasing Part Support Member

As shown in FIG. 21 and FIG. 22, an upper end part of the biasing part 75C is fixed to and supported by a biasing part support member 120 accommodated in the cylindrical member 42D. The biasing part support member 120 is configured by an annular member having a diameter substantially the same as an inner diameter of the lower-end side accommodation chamber 45g of the cylindrical member 42D. The shaft member 68D is inserted into a central through-hole of the biasing part support member 120 in a state where a clearance is provided.

The biasing part support member 120 is arranged in a state where the biasing part support member 120 is pressed against a stepped surface 49 at an upper end of the lower-end side accommodation chamber 45g by a biasing force of the biasing part 75C from below. The biasing part support member 120 is restricted from rotating in a direction around the center axis CX within the cylindrical member 42D by end parts of a pair of holding shafts 122 (see FIG. 22) being inserted in the radial direction from an outside of the cylindrical member 42D via the side-wall shaft holes 121.

An upper end engagement part 115 (see FIG. 17) of the biasing part 75C is locked relative to the biasing part support member 120 in the direction around the center axis CX by being inserted into a slit provided in a side surface of the biasing part support member 120 along the up-down direction. Accordingly, rotation of the upper end part side of the biasing part 75C in the direction around the center axis CX within the cylindrical member 42D is restricted.

### Detaching Operation Part

As shown in FIG. 20 and FIG. 22, the detaching operation part 160 is provided above the cylindrical member 42D. The detaching operation part 160 is a part operated by a user when detaching the tool accessory TT from the tool mounting part 43.

The detaching operation part 160 includes a lever operation part 162 provided on an upper surface part of the power tool 10D, a lever connection part 165 mounted to the upper end part of the shaft member 68D, and an intervening mechanism part 170 that intervenes in connection between the lever operation part 162 and the lever connection part 165. In FIG. 21, for convenience, illustration of the lever operation part 162 and the intervening mechanism part 170 is omitted.

As shown in FIG. 22, the lever operation part 162 is arranged above the cylindrical member 42D. The lever operation part 162 has a lever base end part 163 having a circular upper surface and a lever part 164 extending in one direction from a side surface of the lever base end part 163. The lever base end part 163 is arranged at a position where the center axis CX passes through a center thereof.

When a user puts a finger on the lever part 164 and applies a force in a direction around the center axis CX, the lever operation part 162 rotates in the direction around the center axis CX with the center of the lever base end part 163 as a fulcrum. Although illustration and detailed description thereof are omitted, a biasing member is provided in the lever operation part 162, the biasing member generating an elastic force in a direction to return the lever part 164 to an initial position before a rotation operation by the user. The initial position of the lever part 164 is, for example, a position shown in FIG. 20.

As shown in FIG. 20, the lever connection part 165 is accommodated in a main housing 11 of the power tool 10D. The lever connection part 165 is arranged below the lever operation part 162. As shown in FIG. 22, the lever connection part 165 has a cylindrical connection part 166 configuring a body part thereof and a pair of locking parts 167 provided on a side surface of the cylindrical connection part 166.

As shown in FIG. 21, the cylindrical connection part 166 is fitted onto an outer periphery of the upper end part of the shaft member 68D extending from the upper end of the cylindrical member 42D. The lever connection part 165 is fastened to the upper end part of the shaft member 68D by a fastening screw SC inserted into the cylindrical connection part 166. The lever connection part 165 is restricted from rotating in a direction around the center axis CX relative to the shaft member 68D by the cylindrical connection part 166 being engaged with the upper end part of the shaft member 68D.

The pair of locking parts 167 is a pair of plate-like parts extending from a side surface of the cylindrical connection part 166 to both sides in the radial direction. A pair of leg parts 173 of the intervening mechanism part 170, which will be described below, is locked to the pair of locking parts 167.

As shown in FIG. 20 and FIG. 22, a side end surface of each of the pair of locking parts 167 of the lever connection part 165, to which each of the pair of leg parts 173 of the intervening mechanism part 170 is locked, has a first locking surface part 168a and a second locking surface part 168b. The first locking surface part 168a and the second locking surface part 168b are aligned in the up-down direction.

The first locking surface part 168a is located on a lower end part side of the side end surface of each locking part 167 and extends in a direction along the center axis CX. The second locking surface part 168b is formed at an upper end side corner of each locking part 167. The second locking surface part 168b is inclined relative to the direction of the center axis CX so as to face upward. Functions of the first locking surface part 168a and the second locking surface part 168b will be described later.

As shown in FIG. 20 and FIG. 22, the intervening mechanism part 170 is arranged between the lever operation part 162 and the lever connection part 165. As shown in FIG. 22, the intervening mechanism part 170 includes a disc-shaped flat plate part 171, a fitting protruding part 172 protruding upward at a center of the flat plate part 171, and a pair of plate-like leg parts 173 extending downward from ends on both sides in the radial direction of the flat plate part 171.

As shown in FIG. 20, the flat plate part 171 and the pair of leg parts 173 of the intervening mechanism part 170 are accommodated together with the lever connection part 165 in the main housing 11 of the power tool 10D. The fitting protruding part 172 of the intervening mechanism part 170 protrudes upward from an inside of the main housing 11 and is fixed in a state where the fitting protruding part 172 is fitted into a connection hole part (not shown) provided at a center of a lower surface of the lever base end part 163 of the lever operation part 162. The intervening mechanism part 170 rotates together with the lever operation part 162 when the lever operation part 162 is rotated by a user.

As shown in FIG. 20, in the power tool 10D, each of the pair of leg parts 173 of the intervening mechanism part 170 extends to a position below each locking part 167 sideways of a corresponding one of the pair of locking parts 167 of the lever connection part 165. Each of the pair of leg parts 173 is arranged at a position where a side end surface thereof comes into contact with and is locked relative to a corresponding side end surface of each locking part 167 of the lever connection part 165 in the direction around the center axis CX when the lever operation part 162 is rotated.

As shown in FIG. 22, the side end surface of each of the pair of leg parts 173 of the intervening mechanism part 170, to which each of the pair of locking parts 167 of the lever connection part 165 is locked, has a first side end surface part 175a and a second side end surface part 175b. The first side end surface part 175a and the second side end surface part 175b are aligned in the up-down direction.

The first side end surface part 175a is located on an upper end part side of the side end surface of each leg part 173 and extends in the direction along the center axis CX. The second side end surface part 175b is located at a lower end of each leg part 173. The second side end surface part 175b is inclined relative to the direction of the center axis CX so as to face downward. Functions of the first side end surface part 175a and the second side end surface part 175b will be described later.

### 4-2. Mechanism of the Mounting Mechanism During Attachment and Detachment of Tool Accessory

### 4-2-1. Mechanism During Attachment of Tool Accessory

As described above, a biasing force control mechanism 90D provided in the mounting mechanism 40D of the fourth embodiment is basically the same as the biasing force control mechanism 90C of the third embodiment. The biasing force control mechanism 90D is configured by at least the cylindrical member 42D, the shaft member 68D, and the biasing part 75C.

A mechanism of attaching the tool accessory TT to the mounting mechanism 40D of the fourth embodiment by an action of the biasing force control mechanism 90D is substantially the same as a mechanism when the opening/closing mechanism 55 is opened, which was described in the third embodiment with reference to FIG. 19. The following description will be easily understood by referring to FIG. 19 along with FIG. 21 as appropriate.

At the time of attachment of the tool accessory TT, a pair of closed claws 59 of the opening/closing mechanism 55 is inserted into a mounting hole TH of the tool accessory TT in a state where the opening/closing mechanism 55 is closed. At this time, when the downward extending parts 113 of the moving part 62D are pushed upward against the biasing force of the biasing part 75C by an inner peripheral edge part of the mounting hole TH, the shaft member 68D moves upward together with the moving part 62D. Then, the protruding part 70 moves from the first groove part 51C to the second groove part 52C in the groove 50C of the cylindrical member 42D. As a result, the biasing force of the biasing part 75C in the rotating direction RD is released, and the shaft member 68D rotates in the rotating direction RD by the biasing force.

Then, the protruding part 70 moves obliquely upward along the second groove part 52C, and the moving part 62D moves upward together with the shaft member 68D. Further, the opening/closing control member 58 held by the moving part 62D moves upward to open the opening/closing mechanism 55, and the tool accessory TT is fixed to the tool mounting part 43. Note that, until the opening/closing mechanism 55 transitions from the closed state to the open state, the pair of leg parts 173 of the intervening mechanism part 170 and the pair of locking parts 167 of the lever connection part 165 in the detaching operation part 160 are at positions spaced apart from each other.

As described above, in the fourth embodiment, at the time of attachment of the tool accessory TT, rotation of the shaft member 68D in the rotating direction RD and movement thereof in the direction of the center axis CX are guided with low friction by the shaft support part 130, and are facilitated. Therefore, the opening/closing mechanism 55 can be opened even when a force for pushing upward the downward extending parts 113 of the moving part 62D by the tool accessory TT is small. In addition, since a movement speed of the moving part 62D by the biasing force of the biasing part 75C can be increased, the opening/closing mechanism 55 can be opened more instantaneously. Accordingly, fixation of the tool accessory TT to the opening/closing mechanism 55 is facilitated.

### 4-2-2. Mechanism During Detachment of Tool Accessory

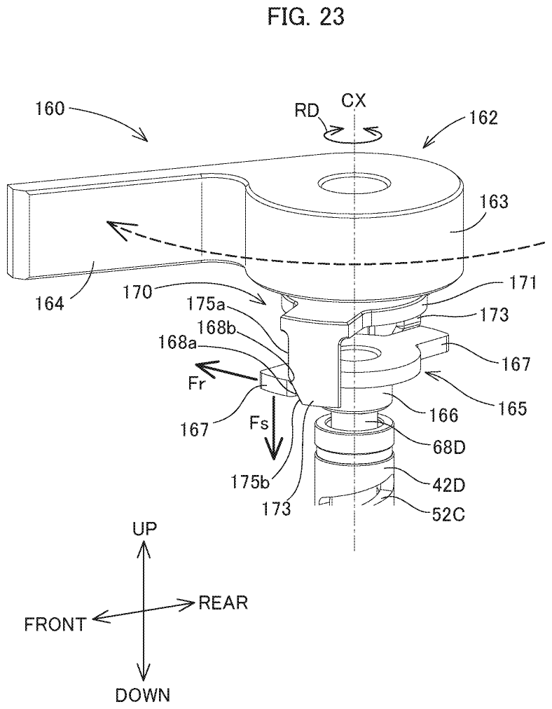

Reference is made to FIG. 20 and FIG. 23. FIG. 20 illustrates a state in which the opening/closing mechanism 55 is opened and the tool accessory TT is fixed. FIG. 23 illustrates the detaching operation part 160 when the opening/closing mechanism 55 is closed to detach the tool accessory TT.

Referring to FIG. 20, in a state in which the opening/closing mechanism 55 is opened and the tool accessory TT is fixed to the tool mounting part 43, the lever part 164 of the lever operation part 162 of the detaching operation part 160 extends rearward from the lever base end part 163. In this state, the first side end surface part 175a of each of the pair of leg parts 173 of the intervening mechanism part 170 and the first locking surface part 168a of each of the pair of locking parts 167 of the lever connection part 165 face each other. The first side end surface part 175a and the first locking surface part 168a may be in surface contact with each other.

When detaching the tool accessory TT, as shown in FIG. 23, a user rotates the lever operation part 162 in a direction around the center axis CX. The user rotates the lever part 164 of the lever operation part 162 from the rear toward the front. Then, the first side end surface part 175a of each of the pair of leg parts 173 of the intervening mechanism part 170 pushes the first locking surface part 168a of each of the pair of locking parts 167 of the lever connection part 165, and the shaft member 68D starts rotating in the rotating direction RD together with the lever connection part 165.

When the shaft member 68D starts rotating, the protruding part 70 starts moving obliquely downward along the second groove part 52C of the groove 50C. When the protruding part 70 starts moving obliquely downward, the shaft member 68D and the lever connection part 165 start moving downward while rotating. Accordingly, the opening/closing control member 58 starts moving downward together with the moving part 62D, and the opening/closing mechanism 55 starts closing.

At this stage, each of the pair of leg parts 173 of the intervening mechanism part 170 and each of the pair of locking parts 167 of the lever connection part 165 are locked together at surfaces along the center axis CX. Therefore, an external force applied by a user to rotate the lever operation part 162 can be more reliably transmitted as a force in a direction to rotate the shaft member 68D in the rotating direction RD. Accordingly, movement of the protruding part 70 along the second groove part 52C in accordance with the external force applied to the lever operation part 162 can be facilitated.

Further, as described above, the shaft member 68D is supported by the shaft support part 130 in an appropriate posture in which displacement from the center axis CX is suppressed, and movement thereof is guided with low friction by the rolling bodies 131 of the shaft support part 130. As a result, since the movement of the protruding part 70 along the second groove part 52C of the groove 50C is further facilitated, the operation when the opening/closing mechanism 55 starts closing in response to the operation of the lever operation part 162 by the user is further facilitated.

As the user continues the rotation operation of the lever part 164 of the lever operation part 162, the rotation and downward movement of the lever connection part 165 and the shaft member 68D are continued, and the protruding part 70 reaches an end part of the second groove part 52C. As a result, as shown in FIG. 23, the lever connection part 165 moves downward relative to the intervening mechanism part 170. Therefore, the second side end surface part 175b, which configures an inclined surface of each of the pair of leg parts 173 of the intervening mechanism part 170, comes into a state of being locked to the second locking surface part 168b, which similarly configures an inclined surface of each of the pair of locking parts 167 of the lever connection part 165.

By the pair of leg parts 173 and the pair of locking parts 167 being locked to each other at the respective inclined surfaces 175b and 168b, a force $Fr$ for rotating the shaft member 68D and a force $Fs$ for moving the shaft member 68D in the first direction are generated as shown in FIG. 23. The force $Fs$ acts in a direction to reliably move the protruding part 70 to a lower end of the first groove part 51C. Accordingly, the opening/closing control member 58 can be reliably moved to the lowermost position, and it is possible to suppress a state in which the opening/closing mechanism 55 is not completely closed.

In this step as well, since the shaft member 68D is guided by the shaft support part 130, the movement of the protruding part 70 along the second groove part 52C due to the action of the force $Fs$ is further facilitated. Therefore, the opening/closing mechanism 55 can be more reliably closed in response to the rotation operation of the lever operation part 162 by the user.

As described above, in the detaching operation part 160, the intervening mechanism part 170 is configured to generate the force $Fr$ for rotating the shaft member 68D and the force $Fs$ for moving the shaft member 68D downward when the lever operation part 162 is rotated around the center axis CX. Thereby, the downward movement of the moving part 62D due to the rotation of the lever operation part 162 can be further facilitated. Accordingly, return of the opening/closing mechanism 55 to the closed state can be performed more smoothly, and detachment of the tool accessory TT can be further facilitated.

### 4-3. Configuration of Spindle Holding Mechanism

Referring to FIG. 20, a spindle holding mechanism 35D of the power tool 10D includes a first rotation support part 181 and a second rotation support part 182. The first rotation support part 181 and the second rotation support part 182 are provided so as to surround an outer periphery of the cylindrical member 42D. In FIG. 21 and FIG. 22, arrangement regions of the first rotation support part 181 and the second rotation support part 182 relative to the cylindrical member 42D are illustrated by broken lines.

The first rotation support part 181 and the second rotation support part 182 support the cylindrical member 42D, which configures a body part of the spindle 30D, in a state where the cylindrical member 42D is allowed to rotate around the center axis CX together with the tool accessory TT. The first rotation support part 181 and the second rotation support part 182 are configured by, for example, ball bearings. By the first rotation support part 181 and the second rotation support part 182, an arrangement posture of the cylindrical member 42D during driving of the power tool 10D can be stabilized, and rotation of the cylindrical member 42D around the center axis CX can be facilitated.

The first rotation support part 181 is provided at a position close to an upper end part of the cylindrical member 42D. By the first rotation support part 181, a fluctuation in a position of the upper end part of the cylindrical member 42D can be suppressed while the tool accessory TT is oscillated in a direction around the center axis CX at a lower end part of the cylindrical member 42D. Accordingly, a fluctuation of the arrangement posture of the cylindrical member 42D within the main housing 11 during driving of the power tool 10D can be more effectively suppressed.

The first rotation support part 181 is arranged at a position where an inner peripheral surface thereof faces the groove part 50C of the cylindrical member 42D. Thereby, at least a part of the groove part 50C is in a state of being covered from an outside of the cylindrical member 42D by the first rotation support part 181. Accordingly, the protruding part 70 of the shaft member 68D can be suppressed from protruding outward from the cylindrical member 42D through the groove part 50C due to an impact, a centrifugal force during rotation of the shaft member 68D, or the like during driving of the power tool 10D. Further, during assembly of the mounting mechanism 40D, it is possible to suppress the protruding part 70 from protruding through the groove part 50C and falling off from the shaft member 68D, or to suppress a length of the protruding part 70 protruding from both sides of the shaft member 68D from becoming uneven. Furthermore, for example, foreign matter such as dust generated during work with the power tool 10D can be suppressed from entering an inside of the cylindrical member 42D through the groove part 50C. Therefore, occurrence of a failure in the power tool 10D due to such dust is suppressed.

The second rotation support part 182 is provided at a central part of the cylindrical member 42D in the up-down direction. By the second rotation support part 182, a position of the central part of the cylindrical member 42D can be fixed during driving of the tool accessory TT. Accordingly, a fluctuation of the arrangement posture of the cylindrical member 42D within the main housing 11 during driving of the power tool 10D can be further effectively suppressed.

The spindle holding mechanism 35D further includes a cover member 183. The cover member 183 is configured by an annular member and is arranged below the first rotation support part 181 so as to surround the outer periphery of the cylindrical member 42D. The cover member 183 is arranged on a step between the upper-end side accommodation chamber 45f and the lower-end side accommodation chamber 45g. In FIG. 21 and FIG. 22, an arrangement region of the cover member 183 relative to the cylindrical member 42D is illustrated by broken lines.

The cover member 183 functions as a spacer member that supports the first rotation support part 181 from below. In addition, the cover member 183 is arranged so as to cover the groove part 50C together with the first rotation support part 181. Accordingly, by the cover member 183, protrusion of the protruding part 70 from the groove part 50C and entry of foreign matter such as dust from the groove part 50C can be more reliably suppressed.

### 4-4. Summary of Fourth Embodiment

As described above, according to the power tool 10D of the fourth embodiment, in the mounting mechanism 40D, the shaft member 68D is supported by the shaft support part 130 in a low-friction state. Accordingly, movement of the shaft member 68D within the cylindrical member 42D can be facilitated, and attachment and detachment of the tool accessory TT to and from the opening/closing mechanism 55 can be further facilitated. Further, according to the power tool 10D of the fourth embodiment, since the detaching operation part 160 is provided in the mounting mechanism 40D, detachment of the tool accessory TT from the opening/closing mechanism 55 in response to a rotation operation of the lever operation part 162 by a user can be performed more smoothly. Furthermore, according to the power tool 10D of the fourth embodiment, rotation of the cylindrical member 42D, which configures the body part of the spindle 30D, can be facilitated by the first rotation support part 181 of the spindle holding mechanism 35D. In addition, by the first rotation support part 181, protrusion of the protruding part 70 from the groove part 50C and entry of foreign matter into the cylindrical member 42D through the groove part 50C can be suppressed. Therefore, occurrence of a failure caused by providing the groove part 50C in the cylindrical member 42D can be suppressed.

### 5. Others

The techniques of the present disclosure are not limited to the configurations of the above-described embodiments and the configurations described as other embodiments in the above-described embodiments. The techniques of the present disclosure can be appropriately modified within a scope that does not depart from the technical idea of the present disclosure. Further, the techniques of the present disclosure may be realized by other modes without being limited to the power tool. The techniques of the present disclosure may be realized by, for example, modes such as a mounting mechanism capable of mounting a tool accessory, a structure of a mounting mechanism, various machines and apparatuses including the mounting mechanism or the structure, a method for mounting a tool accessory, and a method for detaching a tool accessory.

In each of the above-described embodiments, “down” in the up-down direction is one mode of a “first direction” in the techniques of the present disclosure, and “up” is one mode of a “second direction” in the techniques of the present disclosure. Accordingly, in the description of each of the above-described embodiments, “downward direction” can be rephrased as the “first direction”, and “upward direction” can be rephrased as the “second direction”. Note that the “first direction” and the “second direction” are not limited to the “downward direction” and the “upward direction”. The “first direction” and the “second direction” may be a pair of other directions that are opposite to each other.

In the above-described fourth embodiment, instead of the configuration in which the plurality of rolling bodies 131 are arranged in the shaft recess part 132 of the shaft member 68D, the shaft support part 130 may be configured by another support member having a plurality of rolling bodies, such as an oilless bearing or a linear ball bearing. The shaft recess part 132 of the shaft member 68D configuring the shaft support part 130 does not have to be continuous in an annular shape, and may be configured by, for example, hemispherical recess parts in each of which one rolling body 131 is arranged. A recess part in which the rolling bodies 131 of the shaft support part 130 are arranged may be provided on an inner wall surface side of the cylindrical member 42D instead of the shaft recess part 132, or in addition to the shaft recess part 132.

In the above-described fourth embodiment, the lever operation part 162 and the intervening mechanism part 170 of the detaching operation part 160 may be integrated. In the intervening mechanism part 170, the second side end surface part 175b may be configured by a curved surface facing downward, such as a curved surface formed by rounding a lower end corner part thereof. The second locking surface part 168b of the lever connection part 165 may be configured by a curved surface facing upward, such as a curved surface formed by rounding an upper end corner part thereof. The second locking surface part 168b may be omitted.

### DESCRIPTION OF REFERENCE NUMERALS

10, 10D: power tool; 11: main housing; 12: power supply part; 15: rotation drive mechanism; 18: motion conversion mechanism; 20: battery mounting part; 21: control circuit; 23: motor; 24: rotation shaft; 25: eccentric shaft; 26: balancer; 28: bearing; 29: connection arm; 30, 30D: spindle; 35, 35D: spindle holding mechanism; 40A, 40B, 40C, 40D: mounting mechanism; 42A, 42B, 42C, 42D: cylindrical member; 43: tool mounting part; 45a: first accommodation chamber; 45b: second accommodation chamber; 45c: upper accommodation chamber; 45d: middle accommodation chamber, 45e: lower accommodation chamber; 45f: upper-end side accommodation chamber; 45g: lower-end side accommodation chamber; 46: partition wall part; 47: shaft hole; 48: lateral groove; 49: step surface; 50A, 50B, 50C: groove part; 51A, 51B, 51C: first groove part; 52A, 52B, 52C: second groove part; 53: bottom part; 54: locking inner wall surface; 55: opening/closing mechanism; 56: rotation member; 57: rotation shaft member; 58: opening/closing control member; 59: claw part; 60: through groove; 62A, 62B, 62C, 62D: moving part; 63: cylindrical part; 63g: circumferential groove; 64: extending end part; 65: support hole; 66: plate-like part; 68A, 68B, 68C, 68D: shaft member; 70: protruding part; 72: shaft end part; 75A, 75B, 75C: biasing part; 75a: first biasing member; 75b: second biasing member; 77: cylindrical moving body; 78: through window part; 79: vertical groove; 80: through hole part; 81: inclined wall surface; 85A, 85B: tool detaching mechanism; 86, 86C: lever member; 86a: finger-hooking part; 86b: disc part; 86c: circumferential wall part; 86d: disc-shaped body part; 86e: lower cylindrical part; 86f: plate part; 87: lever mounting shaft; 88: lever biasing member; 89A, 89B: lever contact part; 89e: extending wall part; 89s: inclined side end surface; 89t: inclined upper end surface; 90A, 90B, 90C, 90D: biasing force control mechanism; 92: rotation member; 93: upper-end side cylindrical part; 94: downward extending part; 94f: contacted part; 95: protruding part; 95r: recessed part; 96: lateral moving body; 96s: slit; 97: contact part; 97s: inclined end surface; 101: upper end through hole; 102: lower end groove part; 105: flange part; 106: flange part; 107: annular groove part; 110: curved side wall part; 111: fitting part; 112: fitting groove; 113: downward extending part; 115: upper end engaging part; 120: biasing part support member; 121: side wall shaft hole; 122: holding shaft; 130: shaft support part; 131: rolling body; 132: shaft recess part; 140: lower end flange part; 142: lower end connection part; 143: screw mounting part; 144: fastening screw, 145: annular member; 150: cylindrical body part; 151: lateral opening part; 152: inner peripheral edge wall part; 160: detaching operation part; 162: lever operation part; 163: lever base end part; 164: lever part; 165: lever connection part; 166: cylindrical connection part; 167: locking part; 168a: first locking surface part; 168b: second locking surface part; 170: intervening 10 mechanism part; 171: flat plate part; 172: fitting protruding part; 173: leg part; 175a: first side end surface part; 175b: second side end surface part; 181: first rotation support part; 182: second rotation support part; 183: cover member; P1, P2, P3: operation step; RD: rotating direction; PD: lever rotation direction; SC: fastening screw, TH: mounting hole; TM: mounting part; TT: tool accessory; BT: battery; CX: center axis; DX: drive axis; Fa, Fb: biasing force; Fr, Fs: force.

1. A power tool configured to perform an operation on a workpiece by oscillating a tool accessory, comprising:
an opening/closing mechanism that opens and closes, and allows attachment and detachment of the tool accessory when closed, while fixing the tool accessory when opened;
a moving part that is connected to the opening/closing mechanism so as to be movable in a first direction and a second direction opposite to the first direction, and operates the opening/closing mechanism in a closing direction when moved in the first direction, while operating the opening/closing mechanism in an opening direction when moved in the second direction; and
a biasing force control mechanism, including a shaft member that has one end connected to the moving part and moves together with the moving part, a biasing part that generates a biasing force, and a cylindrical member that surrounds an outer periphery of the shaft member and houses the biasing part and the moving part, the biasing force control mechanism being configured to switch the state of application of the biasing force, wherein:
(a) in a closed state of the opening/closing mechanism, the biasing force control mechanism applies the biasing force to hold the opening/closing mechanism in the closed state; and
(b) when a prescribed external force is applied against the biasing force from the tool accessory in said closed state, the biasing force control mechanism applies the biasing force to the shaft member in a direction to move the moving part in the second direction by changing a state of the shaft member locked to the cylindrical member.

2. The power tool as defined in claim 1, wherein:
the biasing part is configured to generate, as the biasing force, a biasing force for biasing the moving part in the first direction and a biasing force for biasing the shaft member in a rotating direction around a center axis;
the biasing force control mechanism is configured such that:
(a) the shaft member moves in the second direction together with the moving part as the shaft member rotates in the rotating direction relative to the cylindrical member;
(b) in the closed state of the opening/closing mechanism, the biasing force control mechanism applies the biasing force to the moving part to restrict movement of the moving part in the second direction, while restricting the shaft member from rotating by the biasing force in the rotating direction by locking the shaft member to the cylindrical member; and
\textcircled{C} when the prescribed external force is applied in said closed state, the biasing force control mechanism releases the shaft member from being locked in the rotating direction so as to rotate the shaft member in the rotating direction relative to the cylindrical member by the biasing force applied in the rotating direction, thereby moving the shaft member in the second direction.

3. The power tool as defined in claim 2, wherein:
the biasing part consists of a torsion spring disposed around an outer periphery of the shaft member and
the torsion spring is configured to generate the biasing force in the rotating direction by torsional deformation in a winding direction, and to generate the biasing force in the first direction by contracting/extending deformation.

4. The power tool as defined in claim 2, wherein:
the shaft member includes a protruding part that is formed on an outer peripheral surface thereof and protrudes toward the cylindrical member;
the cylindrical member includes a groove into which the protruding part is inserted and that defines a path along which the protruding part moves;
the groove includes:
(a) a restricted region that extends in a direction along a center axis of the shaft member and restricts the protruding part from moving in the rotating direction by locking the protruding part in the rotating direction, and
(b) an allowed region that bends and extends from the restricted region in an oblique direction between the rotating direction and the second direction and allows the protruding part to move in the rotating direction; and
the biasing force control mechanism is configured to position the protruding part in the restricted region in the closed state of the opening/closing mechanism, and to move the shaft member in the second direction, thereby moving the protruding part to the allowed region when the prescribed external force is applied in said closed state of the opening/closing mechanism.

5. The power tool as defined in claim 2, further comprising a shaft support part that is provided within the cylindrical member, and includes a plurality of rolling bodies arranged around the shaft member, wherein the shaft support part guides rotation of the shaft member in the rotating direction and movement of the shaft member in the first and second directions by rolling of the rolling bodies.

6. The power tool as defined in claim 4, wherein:
the groove is formed so as to pass through a wall of the cylindrical member; and
a rotation support part is arranged around the cylindrical member to face the groove, the rotation support part supporting the cylindrical member in a state of allowing the cylindrical member to rotate around the center axis together with the tool accessory when the tool accessory oscillates.

7. The power tool as defined in claim 2, further comprising:
a lever operation part arranged above the cylindrical member and configured to be turned by a user in a direction around the center axis of the shaft member;
a lever connection part arranged below the lever operation part and connected to an upper end part of the shaft member so as to rotate in the rotating direction around the center axis together with the shaft member; and
an intervening member that is provided between the lever operation part and the lever connection part, the intervening member being configured to generate a force of rotating the shaft member in the direction around the center axis and a force to move the shaft member in the first direction when the lever operation part is turned around the center axis.

8. The power tool as defined in claim 1, wherein:
the shaft member is arranged so as to be rotatable in a rotating direction around a center axis relative to the cylindrical member;
the biasing part includes a biasing member that biases the shaft member in the second direction;
the biasing force control mechanism is configured to, when the shaft member rotates in the rotating direction, switch between:
(a) a state in which the shaft member is locked to the cylindrical member to restrict the shaft member from moving in the second direction; and
(b) a state in which the shaft member is released from being locked to the cylindrical member to allow the shaft member to move in the second direction,
wherein the biasing force control mechanism is configured to:
restrict the shaft member from moving in the second direction in the closed state of the opening/closing mechanism, and
rotate the shaft member to release restriction of movement of the shaft member and allow the shaft member to move in the second direction by the biasing force, when a prescribed external force is applied in the closed state of the opening/closing mechanism.

9. The power tool as defined in claim 1, wherein:
the shaft member includes a protruding part formed on an outer peripheral surface thereof and protrudes toward the cylindrical member;
the cylindrical member includes a groove into which the protruding part is inserted, the groove defining a path along which the protruding part moves;
the groove includes:
(a) a restricted region that extends in the rotating direction and restricts the protruding part from moving in the second direction, and
(b) an allowed region that is bent and extends from the restricted region in the second direction to allow the protruding part to move in the second direction; and
the biasing force control mechanism is configured to position the protruding part in the restricted region in the closed state of the opening/closing mechanism, and to rotate the shaft member to displace the protruding part to the allowed region when the prescribed external force is applied in said closed state of the opening/closing mechanism.

10. The power tool as defined in claim 1, wherein:
the biasing force control mechanism further includes a cylindrical moving body arranged to surround the outer periphery of the shaft member within the cylindrical member so as to be movable in the first and second directions relative to the opening/closing mechanism, the cylindrical moving body having a through hole into which the protruding part is inserted;
the through hole has an inclined wall surface that is inclined obliquely relative to the rotating direction and guides the protruding part in contact therewith;
the biasing part includes:
a first biasing member that biases the cylindrical moving body in the first direction, and
a second biasing member that biases the moving part in the second direction;
wherein the biasing force control mechanism is configured to:
position the protruding part at an end part of the inclined wall surface on a side of the second direction by a biasing force of the first biasing member in the closed state of the opening/closing mechanism, and
rotate the shaft member so as to move the shaft member in the second direction by a biasing force of the second biasing member, thereby the cylindrical moving body moves in the second direction and the protruding part moves in the rotating direction along the inclined wall surface, when the prescribed external force is applied in the closed state of the opening/closing mechanism.

11. The power tool as defined in claim 1, wherein:
the biasing force control mechanism includes a rotating member provided around the shaft member and connected to the shaft member so as to be rotatable around a center axis relative to the shaft member and the cylindrical member;
the rotating member has a convex part formed on an outer peripheral surface thereof facing an inner wall surface of the cylindrical member and protruding toward the cylindrical member;
the cylindrical member has a groove in which the convex part is housed, the groove defining a path along which the convex part moves;
the groove includes:
(a) a restricted region having a locking inner wall surface that locks the convex part in the second direction to restrict the convex part from moving in the second direction; and
(b) an allowed region that extends from the restricted region in an oblique direction between the rotating direction and the second direction to allow the convex part to move in the oblique direction; and
the biasing force control mechanism is configured to:
position the convex part in the restricted region in the closed state of the opening/closing mechanism, thereby restricting the shaft member from moving in the second direction, and
rotate the rotating member to move the convex part to the allowed region, thereby releasing restriction of movement of the shaft member and moving the shaft member in the second direction by action of the biasing force, when the prescribed external force is applied in the closed state of the opening/closing mechanism.

12. The power tool as defined in claim 11, wherein:
the convex part is constituted by a rolling member that is configured to roll at a fixed position; and
the groove has a bottom on which the rolling member rolls.

13. The power tool as defined in claim 11, wherein:
the biasing force control mechanism further includes a side moving body arranged at a side of the opening/closing mechanism so as to be movable in the first and second directions relative to the opening/closing mechanism;
the biasing part includes a biasing member that biases the side moving body in the first direction; and
the side moving body is arranged at a position to abut on the tool accessory to be mounted to the closed opening/closing mechanism, and is configured to:
move in the second direction to abut on the rotating member, thereby rotating the rotating member in the rotating direction, when the side moving body abuts on the tool accessory and receives the prescribed external force exceeding the biasing force in the first direction.

14. The power tool as defined in claim 3, wherein:
the shaft member includes a protruding part that is formed on an outer peripheral surface thereof and protrudes toward the cylindrical member;
the cylindrical member includes a groove into which the protruding part is inserted and that defines a path along which the protruding part moves;
the groove includes:
(a) a restricted region that extends in a direction along a center axis of the shaft member and restricts the protruding part from moving in the rotating direction by locking the protruding part in the rotating direction, and
(b) an allowed region that bends and extends from the restricted region in an oblique direction between the rotating direction and the second direction and allows the protruding part to move in the rotating direction; and
the biasing force control mechanism is configured to position the protruding part in the restricted region in the closed state of the opening/closing mechanism, and to move the shaft member in the second direction, thereby moving the protruding part to the allowed region when the prescribed external force is applied in said closed state of the opening/closing mechanism.

15. The power tool as defined in claim 3, further comprising a shaft support part that is provided within the cylindrical member, and includes a plurality of rolling bodies arranged around the shaft member, wherein the shaft support part guides rotation of the shaft member in the rotating direction and movement of the shaft member in the first and second directions by rolling of the rolling bodies.

16. The power tool as defined in claim 4, further comprising a shaft support part that is provided within the cylindrical member, and includes a plurality of rolling bodies arranged around the shaft member, wherein the shaft support part guides rotation of the shaft member in the rotating direction and movement of the shaft member in the first and second directions by rolling of the rolling bodies.

17. The power tool as defined in claim 14, further comprising a shaft support part that is provided within the cylindrical member, and includes a plurality of rolling bodies arranged around the shaft member, wherein the shaft support part guides rotation of the shaft member in the rotating direction and movement of the shaft member in the first and second directions by rolling of the rolling bodies.

18. The power tool as defined in claim 16, wherein:
the groove is formed so as to pass through a wall of the cylindrical member; and
a rotation support part is arranged around the cylindrical member to face the groove, the rotation support part supporting the cylindrical member in a state of allowing the cylindrical member to rotate around the center axis together with the tool accessory when the tool accessory oscillates.

19. The power tool as defined in claim 17, wherein:
the groove is formed so as to pass through a wall of the cylindrical member; and
a rotation support part is arranged around the cylindrical member to face the groove, the rotation support part supporting the cylindrical member in a state of allowing the cylindrical member to rotate around the center axis together with the tool accessory when the tool accessory oscillates.

20. The power tool as defined in claim 3, further comprising:
a lever operation part arranged above the cylindrical member and configured to be turned by a user in a direction around the center axis of the shaft member;
a lever connection part arranged below the lever operation part and connected to an upper end part of the shaft member so as to rotate in the rotating direction around the center axis together with the shaft member; and
an intervening member that is provided between the lever operation part and the lever connection part, the intervening member being configured to generate a force of rotating the shaft member in the direction around the center axis and a force to move the shaft member in the first direction when the lever operation part is turned around the center axis.
